(19) United States
(12) Patent Application Publication
(10) Pub. No.: US 2007/0092220 A1
(43) Pub. Date: Apr. 26, 2007

(54) System for reproducing video

(75) Inventor: Hideki Tanabe, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/583,840

(22) Filed: Oct. 19, 2006

(30) Foreign Application Priority Data
Oct. 20, 2005 (JP) 2005-305919

(51) Int. Cl. H04N 7/00

(52) U.S. Cl. 386/95

(57) ABSTRACT

A system is provided in which a plurality of video display devices can reproduce the same contents without skip. A viewing system includes a plurality of televisions and a media server connected to a network. A first television includes an image pickup unit, a face image extraction unit extracting face image data of a viewer, a face feature information calculation unit calculating a feature amount of the viewer's face, a viewer specification unit specifying the viewer based on the feature amount, and a viewer configuration information generation unit generating information of a viewer. The media server includes a contents storing unit storing contents, a contents selection unit selecting contents based on the received contents selection control data, and a contents transmission unit transmitting the selected contents to a second television.

### BACKGROUND OF THE INVENTION

1. Field of the Invention

The present invention relates to control of reproduction of a video/audio signal. More particularly, the present invention relates to a system in which reproduction of video and sound is controlled in a plurality of video display devices connected to a network.

2. Description of the Background Art

An apparatus (referred to as a media server hereinafter) is put to practical use which records broadcasted programs, videotaped images, and other video contents into hard disks, optical media, and other recording media to reproduce the video contents on a television, PC (Personal Computer) or any other video display device. Some of media servers have a plurality of video display devices connected via a network. In this case, for example, a video display device is arranged in each of a plurality of rooms, so that the user of the media server can view video contents transmitted from the media server in each room. A viewing system which realizes such a mechanism is disclosed, for example, in Japanese Patent Laying-Open No. 2004-343445.

Furthermore, when the user views the same video contents on a plurality of video display devices, viewing may be broken off, for example, by the user moving to another room. A technique for realizing seamless viewing in such a case is disclosed, for example, in Japanese Patent Laying-Open No. 2004-336310.

In addition, as for a technique of providing the same video contents to any of a plurality of video display devices, for example, Japanese Patent Laying-Open No. 2005-033682 discloses a technique of specifying a viewer according to the position of the viewer to supply video contents. On the other hand, as for supply of video contents, for example, Japanese Patent Laying-Open No. 2002-084523 discloses a technique for protecting the right to contents by controlling display of supplied contents and the like.

### SUMMARY OF THE INVENTION

However, while the number of video contents recorded in a mass storage device increase, it is not easy to put the contents in order. Moreover, when a viewer moves to another room during reproduction of contents or when the contents that was viewed halfway in the past is to be reproduced, the viewer retrieves the contents and skips (so-called “fast forward”) the part that has already been viewed to find the part continued therefrom, which is extremely cumbersome.

The present invention is made to solve the aforementioned problems, and an object of the present invention is to provide a system capable of accurately reproducing contents viewed by a viewer on a plurality of video display devices.

Another object of the present invention is to provide a system capable of displaying the same contents without skip on a plurality of video display devices, independently of the position of the viewer.

In order to achieve the aforementioned objects, in accordance with an aspect of the present invention, a system for reproducing video is provided. The system includes first and second video display devices connected to a network and a video recording and reproduction device connected to said network. The video recording and reproduction device including a recording unit storing video/audio contents having a video/audio signal, a reproduction unit reproducing the video/audio signal, and a distribution control unit responsive to an externally input request for distributing a video/audio signal corresponding to video/audio contents to a sender of the request. The first video display device includes a first acquisition unit acquiring an image signal by picking up an image of a subject, a first calculation unit calculating a feature amount of the subject by analyzing the image signal, an identification information storing unit storing first identification information of the subject and the feature amount related with the first identification information, a first reproduction control unit causing the video recording and reproduction device to reproduce the video/audio contents based on a first reproduction request, a first display unit displaying the video/audio contents reproduced by the video recording and reproduction device, a first acquisition control unit causing the first acquisition unit to acquire an image signal by picking up an image of a first viewer who gives instruction of the reproduction, a first generation unit generating first specification information for specifying the first viewer based on the image signal of the first viewer and the first identification information, and a history transmission unit transmitting the first specification information and a reproduction history related with the first specification information to the video recording and reproduction device. The video recording and reproduction device further includes a history storing unit storing the first specification information and the reproduction history. The second video display device includes a second acquisition unit acquiring an image signal by picking up an image of a subject, a second calculation unit calculating a feature amount of the subject based on the image signal, a second identification information storing unit storing second identification information of the subject and the feature amount related with the second identification information, a second acquisition control unit causing the second acquisition unit to acquire the image signal by picking up an image of a second viewer who inputs a second reproduction request, a second generation unit generating second specification information for specifying the second viewer based on the feature amount and the acquired image signal, a second reproduction control unit causing the video recording and reproduction device to reproduce the video/audio contents requested to be reproduced based on the second specification information and the second reproduction request, and a second display unit displaying the video/audio contents based on the video/audio signal reproduced by the video recording and reproduction device.

Preferably, the first acquisition unit includes a first image pickup unit picking up an image of the subject to output an image signal. The first acquisition control unit controls an image pickup operation by the first image pickup unit. The second acquisition unit includes a second image pickup unit picking up an image of the subject to output an image signal. The second acquisition control unit controls an image pickup operation by the second image pickup unit.

Preferably, the first acquisition unit includes a first signal input unit accepting an input of the image signal generated by picking up an image of the subject. The second acquisition unit includes a second signal input unit accepting an input of the image signal generated by picking up an image of the subject.

Preferably, the first calculation unit calculates a feature amount of the subject by performing a predetermined analysis process.

Preferably, the second calculation unit calculates a feature amount of the subject by performing a predetermined analysis process.

Preferably, the first reproduction control unit transmits the first reproduction request to the video recording and reproduction device. The distribution control unit transmits a video/audio signal corresponding to video/audio contents requested to be reproduced to the first video display device based on the first reproduction request.

Preferably, the second identification information storing unit stores externally input second identification information of the subject and the feature amount related with the second identification information.

Preferably, the second reproduction control unit transmits the second specification information and the second reproduction request to the video recording and reproduction device. The distribution control unit transmits the video/audio contents requested to be reproduced to the second video display device based on the second reproduction request.

Preferably, the first acquisition control unit causes the first acquisition unit to acquire an image signal of the first viewer based on reproduction of the video/audio signal.

Preferably, the video recording and reproduction device further includes a time lag calculation unit calculating a time lag between a first time at which reproduction ends in the first video display device and a second time at which a reproduction instruction is transmitted by the second video display device, and an overlapping reproduction control unit causing the reproduction unit to reproduce a video/audio signal corresponding to the video/audio contents requested to be reproduced back from the first time to a time according to the time lag.

Preferably, the first acquisition unit includes a first image pickup unit picking up an image of the subject to output an image signal. The first acquisition control unit controls an image pickup operation by the first image pickup unit and causes the first image pickup unit to acquire an image signal of the first viewer based on reproduction of the video/audio signal. The second acquisition unit includes a second image pickup unit picking up an image of the subject to output an image signal. The second acquisition control unit controls an image pickup operation by the second image pickup unit. The second calculation unit calculates a feature amount of the subject by performing a predetermined analysis process. The first reproduction control unit transmits the first reproduction request to the video recording and reproduction device. The distribution control unit transmits a video/audio signal corresponding to video/audio contents requested to be reproduced to the first video display device based on the first reproduction request. The second identification information storing unit stores externally input second identification information of the subject and the feature amount related with the second identification information. The second reproduction control unit transmits the second specification information and the second reproduction request to the video recording and reproduction device. The distribution control unit transmits the video/audio contents requested to be reproduced to the second video display device based on the second reproduction request.

In accordance with another aspect of the present invention, a system includes first and second video display devices connected to a network and a video recording and reproduction device connected to said network. The video recording and reproduction device includes a recording unit storing video/audio contents having a video/audio signal, and a reproduction unit reproducing the video/audio signal. The first video display device includes a first acquisition unit acquiring an image signal by picking up an image of a subject, a first transmission unit transmitting the image signal to the video recording and reproduction device, and a first request transmission unit transmitting a first reproduction request externally input to reproduce video/audio contents to the video recording and reproduction device. The video recording and reproduction device further includes an analysis unit calculating a feature amount of an image by performing a predetermined analysis process on the image signal, a viewer information storing unit storing identification information for identifying a viewer and a feature amount related with the identification information, a first calculation unit causing the analysis unit to calculate a first feature amount of a first viewer who makes the first reproduction request based on the image signal from the first video display device, a first reproduction control unit causing the reproduction unit to reproduce a video/audio signal corresponding to video/audio contents requested to be reproduced based on the first reproduction request, a first distribution unit transmitting a read video/audio signal to the first video display device, and a management unit managing a history of reproduction for the first video display device based on the identification information and the first feature amount. The first video display device further includes a first display unit displaying video/audio contents based on a video/audio signal transmitted from the video recording and reproduction device. The second video display device includes a second request transmission unit transmitting a second reproduction request externally input to reproduce video/audio contents to the video recording and reproduction device, a second acquisition unit acquiring an image signal by picking up an image of a subject, and a second transmission unit transmitting the image signal to the video recording and reproduction device. The video recording and reproduction device further includes a second calculation unit causing the analysis unit to calculate a second feature amount of a second viewer who makes the second reproduction request based on the image signal from the second video display device, a retrieval unit retrieving video/audio contents in which the first viewer matches the second viewer based on the identification information, the second feature amount, and the history of reproduction, and a second distribution unit transmitting a video/audio signal corresponding to the video/audio contents retrieved by the retrieval unit to the second video display device. The second video display device further includes a second display unit displaying video/audio contents based on a video/audio signal transmitted by the video recording and reproduction device.

Preferably, the first acquisition unit includes a first image pickup unit picking up an image of the subject to output an image signal. The first acquisition control unit controls an image pickup operation by the first image pickup unit. The second acquisition unit includes a second image pickup unit picking up an image of the subject to output an image signal. The second acquisition control unit controls an image pickup operation by the second image pickup, unit.

Preferably, the first acquisition unit includes a first signal input unit accepting an input of the image signal generated by picking up an image of the subject. The second acquisition unit includes a second signal input unit accepting an input of the image signal generated by picking up an image of the subject.

Preferably, the second acquisition unit acquires the image signal based on an input of the second reproduction request.

Preferably, the management unit includes a first generation unit generating first specification information for specifying the first viewer based on the identification information and the first feature amount, and a reproduction history storing unit storing the first specification information and reproduced video/audio contents. The retrieval unit includes a second generation unit generating second specification information for specifying the second viewer based on the identification information and the second feature amount, and a contents retrieval unit retrieving video/audio contents to be distributed to the second video display device based on the first specification information and the second specification information.

Preferably, the contents retrieval unit retrieves video/audio contents in which the first viewer matches the second viewer.

Preferably, the viewer information storing unit stores the identification information input beforehand to identify a viewer and the feature amount calculated by the analysis process for the image signal of the viewer.

Preferably, the video recording and reproduction device further includes a time lag calculation unit calculating a time lag between a first time at which reproduction ends in the first video display device and a second time at which a reproduction instruction is transmitted by the second video display device, and an overlapping reproduction control unit causing the reproduction unit to reproduce a video/audio signal corresponding to the video/audio contents requested to be reproduced back from the first time to a time according to the time lag.

Preferably, the first acquisition unit includes a first image pickup unit picking up an image of the subject to output an image signal. The first acquisition control unit controls an image pickup operation by the first image pickup unit. The second acquisition unit includes a second image pickup unit picking up an image of the subject to output an image signal based on an input of the second reproduction request. The second acquisition control unit controls an image pickup operation by the second image pickup unit. The management unit includes a first generation unit generating first specification information for specifying the first viewer based on the identification information and the first feature amount, and a reproduction history storing unit storing the first specification information and reproduced video/audio contents. The retrieval unit includes a second generation unit generating second specification information for specifying the second viewer based on the identification information and the second feature amount, and a contents retrieval unit retrieving video/audio contents to be distributed to the second video display device based on the first specification information and the second specification information. The contents retrieval unit retrieves video/audio contents in which the first viewer matches the second viewer. The viewer information storing unit stores the identification information input beforehand to identify a viewer and the feature amount calculated by the analysis process for the image signal of the viewer.

In the system in accordance with the present invention, a viewer of a first video display device and a viewer of a second video display device are authenticated based on respective image signals. When it is confirmed that the viewer of the first video display device is viewing video/audio contents using the second video display device, the video recording and reproduction device distributes the video/audio contents reproduced for the viewer of the first video display device to the second video display device in a continuous manner. As a result, the video/audio contents reproduced in the first video display device is reproduced in the second video display device in a continuous manner.

Therefore, even if a viewer changes the location where he/she views video/audio contents, he/she can view the same contents without performing a complicated operation. Thus, the burden of managing video/audio contents can be reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating a schematic configuration of a viewing system in accordance with a first embodiment of the present invention.

FIG. 2 is a block diagram illustrating a functional configuration of the viewing system.

FIG. 3 is a block diagram illustrating a hardware configuration of a television.

FIG. 4 is a block diagram illustrating a configuration of a function realized by CPU.

FIG. 5 is a diagram schematically illustrating a manner of data storage in a memory.

FIG. 6 is a diagram schematically illustrating a face image stored in the memory.

FIG. 7 is a diagram illustrating a room in which a television is installed, as viewed from the top.

FIG. 8 is a flowchart illustrating a procedure of processes performed by CPU and an analysis unit.

FIG. 9 is a flowchart illustrating a procedure of processes performed by CPU to control the operation of the television.

FIG. 10 is a diagram illustrating a configuration of viewer information transmitted by the television to a media server.

FIG. 11 is a block diagram illustrating a hardware configuration of a computer system functioning as a media server.

FIG. 12 is a diagram schematically illustrating a manner of data storage in a hard disk.

FIGS. 13 and 14 are flowcharts illustrating a procedure of processes performed by CPU of the computer system functioning as a media server.

FIG. 15 is a diagram illustrating a manner of data storage in RAM of the computer system.

FIG. 16 is a flowchart illustrating a procedure of processes performed by CPU when a viewer instructs the television to reproduce contents.

FIG. 17 is a diagram schematically illustrating a structure of a reproduction request transmitted from the television to the media server.

FIG. 18 is a flowchart illustrating a procedure of processes performed by the computer system that has received a contents reproduction request.

FIG. 19 is a diagram illustrating a message displayed when contents are reproduced.

FIG. 20 is a block diagram illustrating a functional configuration of a viewing system.

FIG. 21 is a block diagram illustrating a hardware configuration of a television.

FIG. 22 is a diagram illustrating a manner of data storage in a hard disk.

FIG. 23 is a flowchart illustrating a procedure of processes performed by CPU of the television to register a viewer.

FIG. 24 is a flowchart illustrating a procedure of processes performed by CPU when the viewer of the television views contents.

FIG. 25 is a diagram illustrating a signal transmitted by the television to a media server.

FIG. 26 is a flowchart illustrating a procedure of processes performed by CPU to register viewer's information.

FIG. 27 is a flowchart illustrating a procedure of processes performed by CPU when a media server reproduces contents.

FIG. 28 is a diagram illustrating display of a contents list stored in the media server on a display.

FIG. 29 is a flowchart illustrating a procedure of processes performed by CPU.

FIG. 30 is a block diagram illustrating a hardware configuration of a television to which a camera is connected.

FIG. 31 is a block diagram illustrating a hardware configuration of a camera unit.

### DESCRIPTION OF THE PREFERRED EMBODIMENTS

In the following, with reference to the figures, the embodiments of the present invention will be described. In the following description, the same parts will be denoted with the same reference characters. Their designations and functions are also the same. Therefore, detailed description thereof will not be repeated.

<First Embodiment>

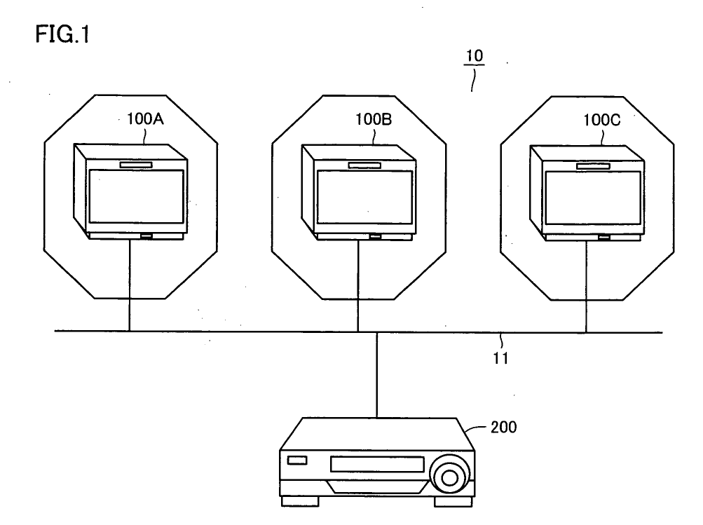

Referring to FIG. 1, a viewing system 10 in accordance with a first embodiment of the present invention will be described. FIG. 1 is a block diagram illustrating a schematic configuration of viewing system 10. Viewing system 10 includes televisions 100A, 100B, 100C and a media server 200. Each television and media server 200 are connected to each other via a network 11. Media server 200 is realized, for example, by a PC, a hard disk recorder or any other video recording and reproduction device.

The televisions are arranged in separate locations. For example, if viewing system 10 is constructed at home, each television is placed in each room. Network 11 is realized, for example, by an optical fiber cable, Ethernet (R), or any other LAN (Local Area Network). It is noted that the televisions 100A, 100B, 100C will collectively be referred to as television 100. Furthermore, the video display device included in the viewing system is not limited to a television as long as the device at least has CRT (Cathode Ray Tube), a liquid crystal display, or any other video display unit.

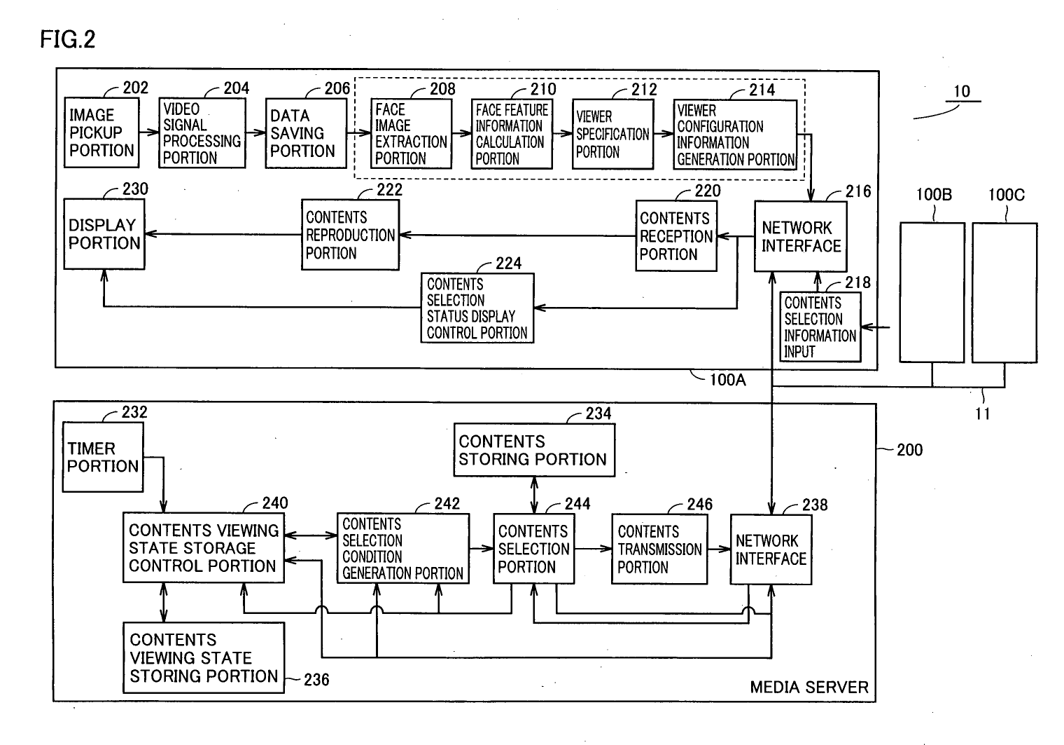

Referring to FIG. 2, the technical idea for realizing viewing system 10 will be described. FIG. 2 is a block diagram illustrating a functional configuration of viewing system 10.

Television 100A includes an image pickup portion 202 picking up an image of a subject to output an image signal, a video signal processing portion 204 generating digital data by performing a predetermined process on the image signal output from image pickup portion 202, a data saving portion 206 saving data output from video signal processing portion 204, a face image extraction portion 208 extracting face image data of the viewer of television 100A based on data stored in data saving portion 206, a face feature information calculation portion 210 calculating a feature amount of the viewer's face based on the data extracted from face image extraction portion 208, a viewer specification portion 212 for specifying the viewer of television 100A based on the feature amount calculated by face feature information calculation portion 210, and a viewer configuration information generation portion 214 generating information of the viewer who views the contents output from television 100A based on viewer information specified by viewer specification portion 212.

Television 100A further includes a network interface 216 connected to network 11 to communicate information via network 11, a contents selection information input portion 218 accepting an input of information for selecting contents to be displayed on television 100A from the outside of television 100A, a contents reception portion 220 receiving contents information transmitted from media server 200, a contents reproduction portion 222 for reproducing the contents received by contents reception portion 220, a contents selection status display control portion 224 obtaining the contents selection status based on the information received through network interface 216 to perform control for outputting the information, and a display portion 230 displaying video based on the contents reproduced by contents reproduction portion 222 or the information output from contents selection status display control portion 224.

Here, contents include video/audio contents having a video/audio signal, such as a broadcasted program, an externally input video image, or any other moving images. In addition, a movie or any other image stored in each recording medium are also equivalent to contents as long as the media server is an apparatus capable of reproducing a DVD or any other recording medium.

Referring again to FIG. 2, media server 200 includes a timer portion 232 keeping time to output time information, a contents storing portion 234 storing externally input information as contents, a contents viewing state storing portion 236 storing a viewing status for each television connected to media server 200, a network interface 238 connected to network 11 to communicate with each of televisions 100A, 100B, 100C, a contents viewing state storage control portion 240 generating information representing the contents viewing state for each television for storage into contents viewing state storing portion 236, a contents selection portion 244 for selecting contents stored in contents storing portion 234 based on contents selection control data received through network interface 238, a contents selection condition generation portion 242 for specifying a contents viewing time, viewer configuration information, viewing location information, and the like based on information of the contents selected by contents selection portion 244, and a contents transmission portion 246 for transmitting data of the contents selected by contents selection portion 244 to a specified television through network interface 238.

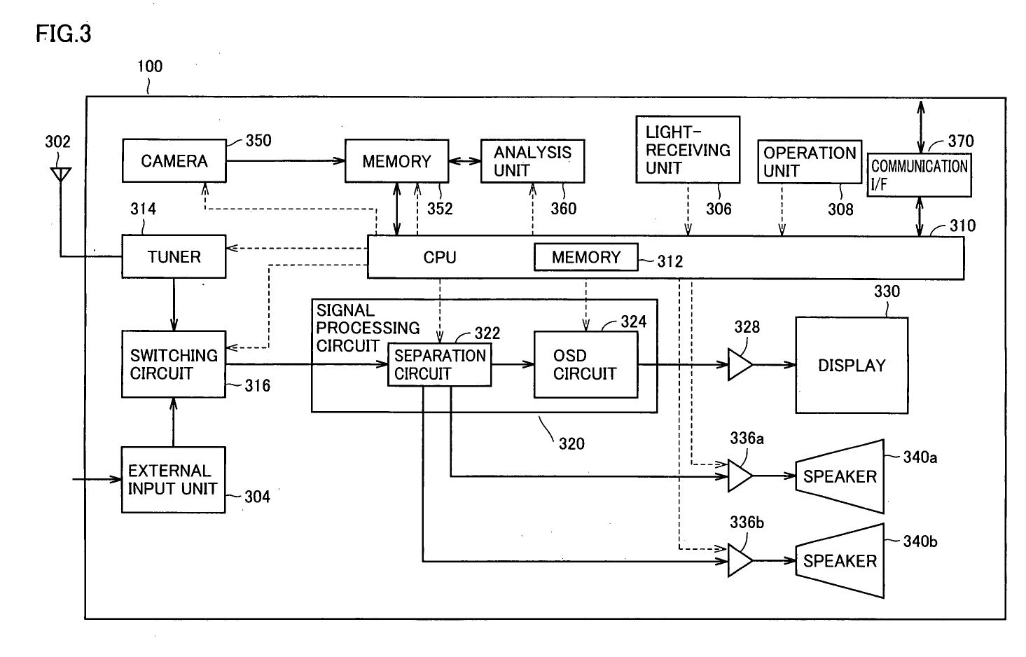

Referring to FIG. 3, a specific configuration of a television in accordance with the present embodiment will be described. FIG. 3 is a block diagram illustrating a hardware configuration of television 100. Television 100 includes an antenna 302, an external input unit 304, a light-receiving unit 306, an operation unit 308, a CPU (Central Processing Unit) 310, a tuner 314, and a switching circuit 316. CPU 310 includes a memory 312. A broadcast signal received by antenna 302 is sent to tuner 314. Tuner 314 selects a channel specified by a control signal output from CPU 310.

External input unit 304 accepts an externally input video/audio signal. For example, external input unit 304 accepts an input of a video/audio signal transmitted from media server 200. The video/audio signal includes, for example, video contents produced by recording a broadcasted program, video contents obtained from a DVD or any other recording medium, or the like. The video/audio signal is transmitted from external input unit 304 to switching circuit 316. External input unit 304 may accept a video signal and an audio signal separately or may be formed by combining cables carrying respective signals. Switching circuit 316 selectively outputs one of a signal output from tuner 314 and a signal output from external input unit 304 based on a switching command output from CPU 310.

Television 100 further includes a camera 350, a memory 352, an analysis unit 360, and a communication I/F (Interface) 370. Camera 350 is realized, for example, by a CCD (Charge Coupled Device) solid-state imaging device.

Memory 352 is, for example, a flash memory. Camera 350 picks up an image of a subject (viewer) based on an image pickup command output from CPU 310 and transmits image data of the subject to memory 352. Memory 352 stores the image data based on a write command output from CPU 310 in a region specified by the command. Analysis unit 360 analyzes the image data obtained from an image picked up by camera 350 based on a command from CPU 310. The analysis process will be described later.

Communication I/F 370 is connected to network 11 to communicate a signal with media server 200. The communicated signal includes a control signal and a video/audio signal.

Referring again to FIG. 3, television 100 includes a signal processing circuit 320, a driver 328, a display 330, amplifiers 336a, 336b, and speakers 340a, 340b. Signal processing circuit 320 includes a separation circuit 322 and an OSD (On Screen Display) circuit 324.

The signal output from switching circuit 316 is input to separation circuit 322. Separation circuit 322 carries out processes for separating a video signal and an audio signal from each other based on a command from CPU 310. The video signal output from separation circuit 322 is input to OSD circuit 324. The audio signal output from separation circuit 322 is transmitted to each of amplifiers 336a, 336b.

OSD circuit 324 generates a signal for displaying an image on display 330 based on a command from CPU 310. The image includes, for example, a channel number and any other character information. Furthermore, the character information includes display representing a volume level and display representing an operation of television 100. The display representing an operation includes volume up or down, a change of contrast, and the like. More specifically, OSD circuit 324 combines a video signal output from separation circuit 322 with an image signal generated based on data stored beforehand in memory 312 and outputs a signal generated by the combination to driver 328.

Driver 328 performs a process of displaying videos on display 330 based on the signal output from OSD circuit 324. Amplifiers 336a, 336b amplify respective audio signals output from separation circuit 322 to respectively transmit to speakers 340a, 340b. Speakers 340a, 340b output sound based on those signals.

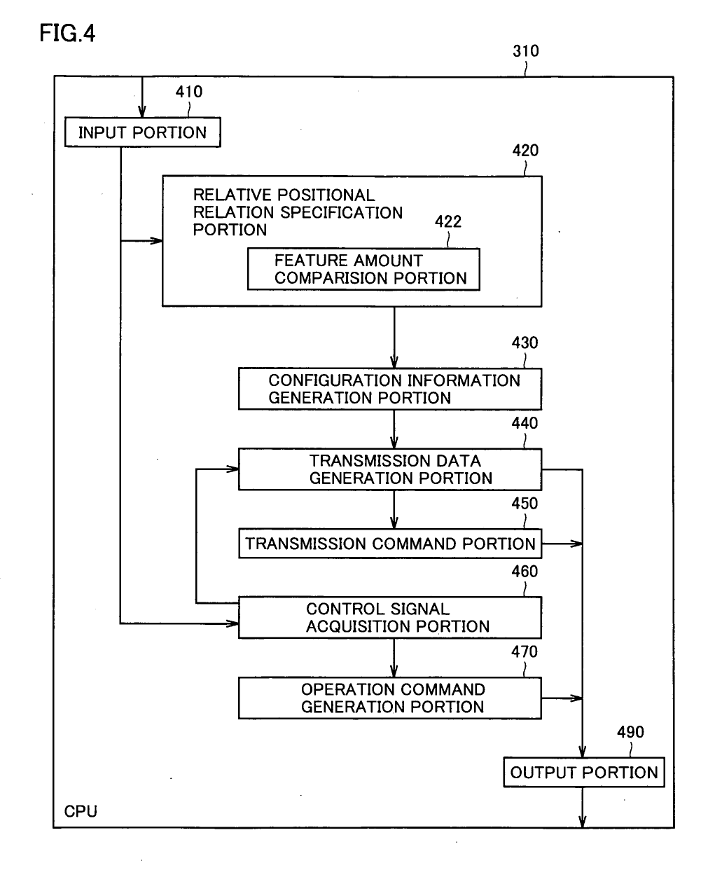

Referring now to FIG. 4, CPU 310 realizing television 100 in accordance with the present embodiment will be described. FIG. 4 is a block diagram illustrating a configuration of the function realized by CPU 310. CPU 310 includes an input portion 410, a relative positional relation specification portion 420, a configuration information generation portion 430, a transmission data generation portion 440, a transmission command portion 450, a control signal acquisition portion 460, an operation command generation portion 470, and an output portion 490.

Input portion 410 accepts an input of a signal from the outside of CPU 310. Here, the outside includes light-receiving unit 306, operation unit 308, and communication I/F 370. CPU 310 further accepts an input of data from analysis unit 360. This data is also sent to the inside through input portion 450.

Relative positional relation specification portion 420 performs a process for specifying the positional relation of a subject imaged by camera 350 based on data stored in memory 352. Specifically, relative positional relation specification portion 420 calculates information representing a distance of a subject from television 100 or a shift in the horizontal direction with respect to the front of television 100. Information representing a shift is represented, for example, based on the number of pixels.

A feature amount comparison portion 422 compares a feature amount stored beforehand with a newly calculated feature amount. The feature amount stored beforehand is calculated from image data acquired by picking up an image of a viewer at a standard viewing location with respect to television 100.

Configuration information generation portion 430 generates information representing a configuration of a viewer who watches television 100 based on information from relative positional relation specification portion 420. This information includes an ID (Identification) for specifying a viewer and data for identifying contents appearing on display 330 of television 100.

Control signal acquisition portion 460 acquires a signal for specifying an operation of television 100 based on data accepted through input portion 410. Operation command generation portion 470 generates a signal for causing television 100 to perform a specified operation based on a signal acquired by control signal acquisition portion 460. Transmission data generation portion 440 generates data to be transmitted to media server 200 via network 11 based on the information generated by configuration information generation portion 430 and the information from control signal acquisition portion 460. Transmission command portion 450 outputs an instruction to transmit data generated by transmission data generation portion 440 to media server 200 via network 11. Output portion 490 outputs a command from transmission command portion 450 or a signal output from operation command generation portion 470 to the outside of CPU 310. The output signal is sent to hardware to be controlled by the signal.

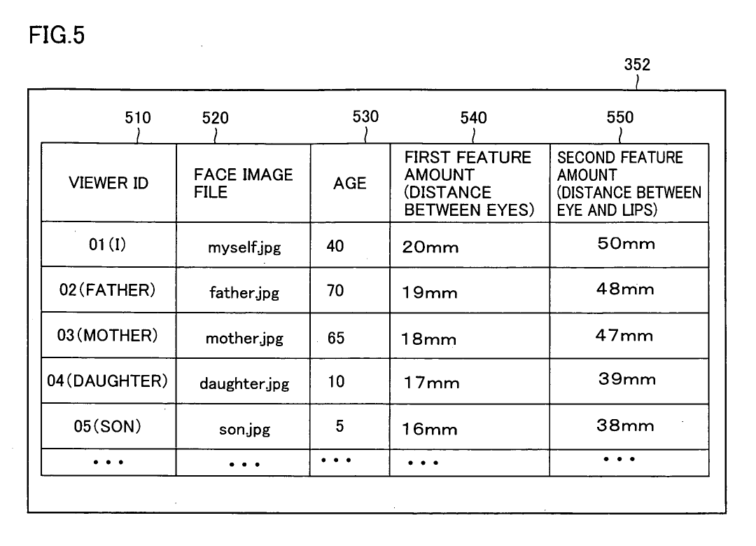

Referring to FIG. 5, a data structure of television 100 will be described. FIG. 5 is a diagram schematically illustrating a manner of data storage in memory 352. Memory 352 includes regions 510, 520, 530, 540, 550 for storing data.

Information for identifying a viewer (a viewer ID) is stored in region 510. Data of a face image acquired by picking up an image of a viewer is stored in region 520. Attribute information of a viewer (for example, age) is stored in region 530. The feature amount of the viewer's face is stored in each of regions 540, 550. The data stored in regions 510 to 550 are related with one another. Therefore, if a viewer ID stored in region 510 is designated, its corresponding data is specified.

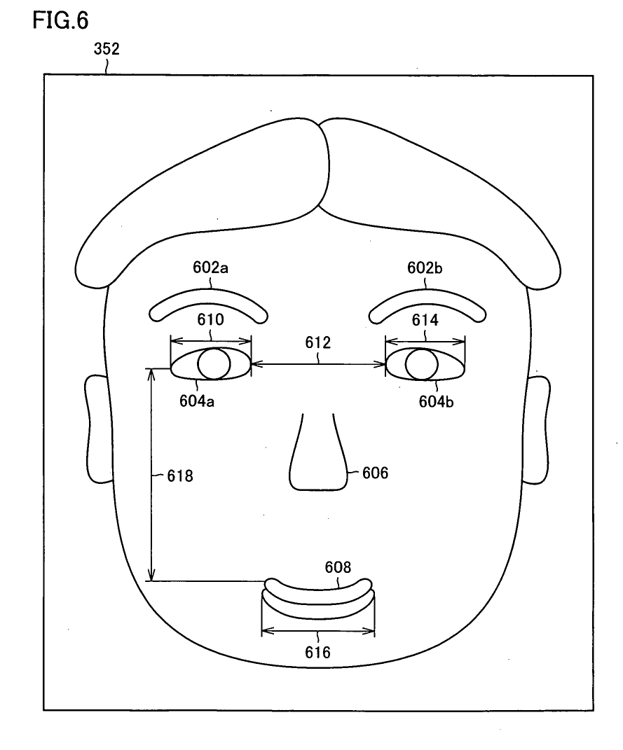

Referring now to FIG. 6, a face image data extraction process in accordance with the present embodiment will be described. FIG. 6 is a diagram schematically illustrating a face image stored in memory 352.

When an image pickup process is performed normally with a subject positioned in front of display 330 of television 100, data generated by the image pickup process is stored in memory 352. The subject's face includes a flesh-colored part and the other part. For example, hair, eyebrows, pupils are, black different from a flesh color. Then, for example, image data binarization processing or grayscale processing is performed on such subject's image, so that an image having different shades of gray is generated.

More specifically, as shown in FIG. 6, eyebrows 602a, 602b, pupils 604a, 604b, nose 606, lip 608 each are extracted. When a region in memory 352 is specified beforehand, for example, a distance between eyes 612, eye lengths 610, 614, a mouth width 616, and a distance between the outer corner of the eye and the center of the lip 618 each are calculated as a relative distance. The distance is represented, for example, by the number of pixels. The value of distance 612 and the value of distance 618 are stored in the regions reserved in memory 352 as horizontal direction information and vertical direction information, respectively. Thus, the location of a subject with respect to the image generated by image pickup of camera 350 can easily be specified.

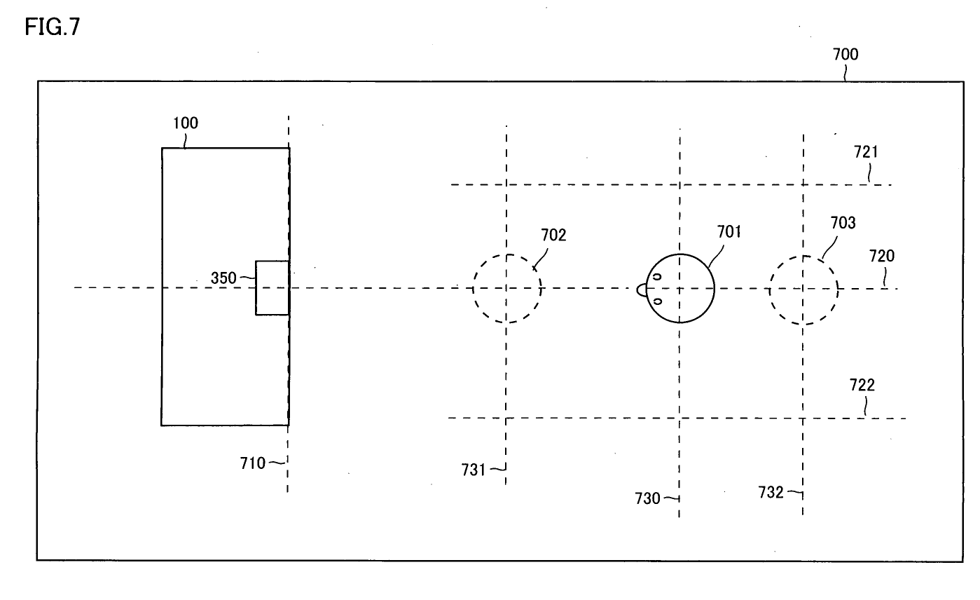

Referring to FIG. 7, “standard position” in use of television 100 in accordance with the present embodiment will be described. FIG. 7 is a diagram illustrating a room where television 100 is installed, as viewed from the top. A viewer 701 is watching television 100 in a room 700. Viewer 701 is located at “standard position” with respect to television 100. Here, the standard position refers to a predetermined position with respect to television 100. This position is specified by the distance from television 100 and the distance from the axis passing through the center of television 100.

In the example shown in FIG. 7, the standard position is the intersection of a dotted line 720 with a dotted line 730. Dotted line 730 corresponds to a position away from a dotted line 710 corresponding to the base position of television 100 by a predetermined distance. Dotted line 720 corresponds to the central line of television 100, for example, such a line that orthogonally intersects display 330.

In this state, viewer 701 makes initial registration at television 100. More specifically, an image of viewer 701 is picked up by camera 350, and analysis unit 360 then recognizes the face image of viewer 701 and calculates the feature amount. As a result, when viewer 701 is recognized correctly, the feature amount is registered at television 100. The image of viewer 701 is picked up by camera 350 every time viewer 701 watches television 100. Thus, a newly calculated feature amount can be compared with the already saved feature amount.

Viewer 701 may watch television 100 at a position closer to television 100 than the standard position. For example, viewer 701 may watch television 100 at a position 702 on a dotted line 731. On the contrary, viewer 701 may watch television 100 at a position 703 corresponding to a dotted line 732 away from television 100. In such a case, the distance between viewer 701 and camera 350 is reduced or increased. In the present embodiment, the ratio between the feature amounts is used to recognize a viewer. For example, the ratio between the distance between the viewer's eyes and the distance between the eye and the lip is used for recognition. In this case, the same viewer would have the ratio having the same value even if the distance from camera 350 varies. Therefore, viewer 701 is not recognized as a different viewer erroneously. Thus, the subsequent operation of television 100 is also realized under control according to viewer 701.

Furthermore, a viewer may watch television 100 at a position shifted from the central axis 720 with respect to television 100. For example, a plurality of viewers watch video on television 100. Specifically, other viewers may watch television 100 at positions on dotted lines 721, 722. Also in this case, the value of the ratio between the feature amounts is not largely shifted from the value of the ratio between the feature amounts that is registered beforehand, so that the same viewer can be authenticated correctly by setting the shift amount as an error in advance.

It is noted that the position different from the standard position is not limited to those shown in FIG. 7. The position at which a video on television 100 can be watched in room 700 may be different from the standard position.

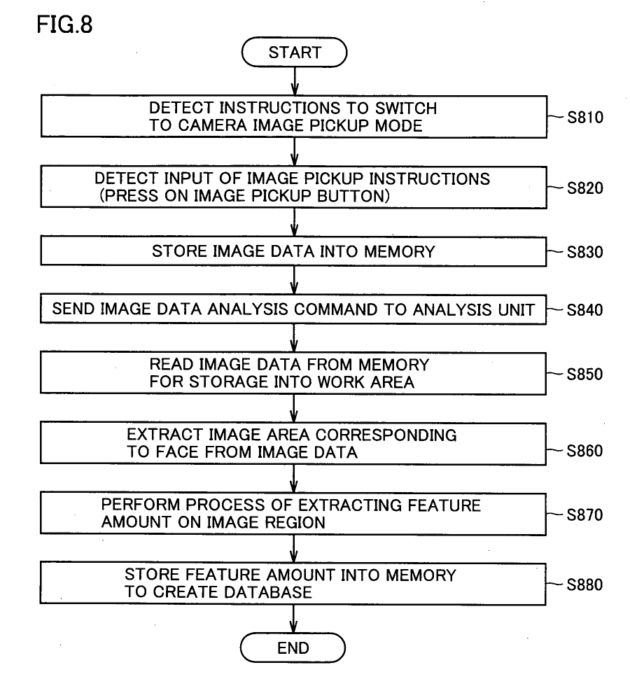

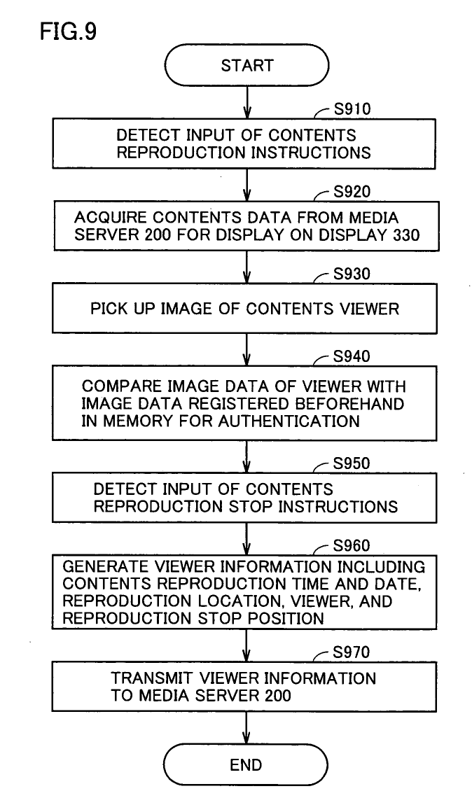

Referring to FIGS. 8 and 9, a control structure of television 100 in accordance with the present embodiment will be described. FIG. 8 is a flowchart illustrating a procedure of processes performed by CPU 310 and analysis unit 360 to initially authenticate a viewer.

At step S810, CPU 310 detects an instruction to switch an operation mode of television 100 to an image pickup mode by camera 350 based on reception of a signal transmitted by a remote control terminal (not shown) input through light-receiving unit 306. At step S820, CPU 310 detects a command of press on an image pickup button (not shown) of camera 350 based on an image pickup instruction signal from the remote control terminal that is received by light-receiving unit 306. CPU 310 outputs a command to camera 350 to pick up an image of a subject in a predetermined image pickup mode. The image pickup mode includes aperture, shutter speed, and the like. Camera 350 performs a subject image pickup process in response to such a command. After the image pickup process, camera 350 sends image data to memory 352.

At step S830, CPU 310 stores data transmitted from camera 350 to memory 352 in a region reserved beforehand in memory 352. At step S840, CPU 310 outputs an instruction to analysis unit 360 for analysis using the data stored in memory 352.

At step S850, analysis unit 360 reads the image data from memory 352 based on the instruction and stores the image data in a work area of RAM (Random Access Memory) (not shown). At step S860, analysis unit 360 extracts an image region corresponding to the viewer's face from the data. This extraction process is realized, for example, using known image processing.

At step S870; analysis unit 360 performs a process for calculating a feature amount on the image region. The calculated feature amount is designated beforehand by CPU 310. At step S880, analysis unit 360 stores the calculated feature amount in a region reserved beforehand in memory 352. As a result, the authentication process of the viewer located at the standard position with respect to television 100 is completed so that the data for specifying the viewer is stored in memory 352 (FIG. 5).

FIG. 9 is a flowchart illustrating a procedure of processes performed by CPU 310 to control the operation of television 100. This process is performed, for example, when a viewer instructs television 100 to reproduce contents.

At step S910, CPU 310 detects an input of a contents reproduction instruction based on a signal from light-receiving unit 306 or a signal from operation unit 308. At step S920, CPU 310 acquires contents data from media server 200 to cause the contents to appear on display 330. At step S930, CPU 310 transmits a signal for image pickup to camera 350 to cause camera 350 to pick up an image of the viewer of the contents.

At step S940, CPU 310 compares the image data of the viewer obtained at step S930 with the image data registered beforehand in memory 352 to perform an authentication process of the viewer who views the contents. At step S950, CPU 310 detects an input of an instruction to stop reproduction of the reproduced contents based on a signal from light-receiving unit 306 or a signal from operation unit 308. At step S960, CPU 310 generates viewer information including the reproduction time and date and reproduction location (that is, an identification number of the television) of the contents, the information of the viewer, and the position at which the reproduction of the contents was stopped. At step S970, CPU 310 transmits the viewer information to media server 200 via network 11.

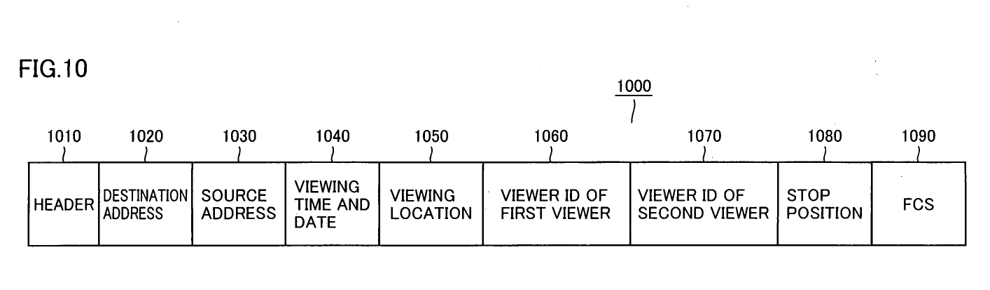

Referring to FIG. 10, communications between television 100 and media server 200 will be described. FIG. 10 is a diagram illustrating a configuration of the viewer information transmitted by television 100 to media server 200. Viewer information 1000 includes a header 1010, a destination address 1020, a source address 1030, viewing time and date 1040, viewing location 1050, a viewer ID of a first viewer 1060, a viewer ID of a second viewer 1070, a contents stop position 1080, and FCS (Frame Check Sequence) 1090.

Destination address 1020 is data for specifying a location of media server 200 in network 11. Source address 1030 is data for specifying a location of television 100 in network 11. Viewing time and date 1040 is, for example, the time and date when the reproduction of contents ended. Viewing location 1050 is, for example, data for identifying television 100 or data for identifying a room where television 100 is installed. Viewer ID 1060 of the first viewer and viewer ID 1070 of the second viewer are data for specifying a viewer authenticated by television 100. Stop position 1080 is data for specifying the position at which reproduction of contents is stopped. This data is, for example, the time from the start of contents, a specific address, or the like.

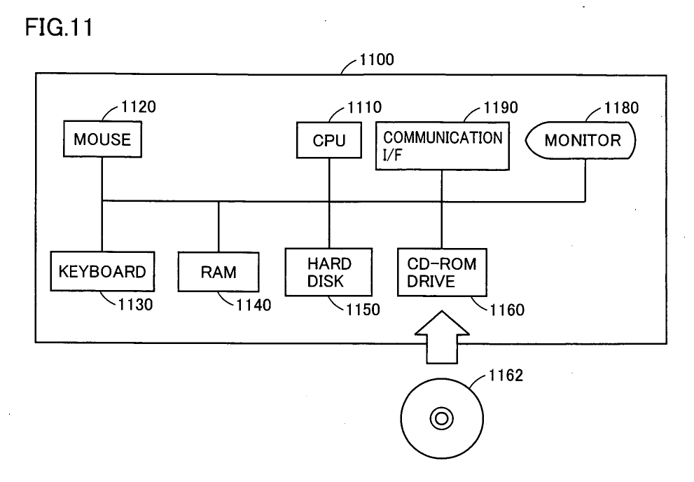

Referring to FIG. 11, a manner of a specific configuration of media server 200 in accordance with the present embodiment will be described. FIG. 11 is a block diagram illustrating a hardware configuration of a computer system 1100 which functions as media server 200.

Computer system 1100 includes a CPU 1110, mouses 1120, 1130 accepting an input of instructions by the user of computer system 1100, an RAM 1140 temporarily storing input data or data generated by execution of a program by CPU 1110, a hard disk 1150 capable of storing a large volume of data in a nonvolatile manner and randomly accessible to the data, a CD-ROM (Compact Disk-Read Only Memory) drive 1160, a monitor 1180, and a communication I/F 1190, which are mutually connected via data bus. A CD-ROM 1162 is inserted into CD-ROM drive 1160.

A process in computer system 1100 is realized by each hardware and software executed by CPU 1110. Such software is stored beforehand in RAM 1140 or hard disk 1150. The software may also be stored in CD-ROM 1162 or any other data recording medium and distributed as a program product. Alternatively, the software may be provided as a downloadable program product by an information provider connected to the Internet or any other communication line. Such software is read from the data recording medium by CD-ROM drive 1160 or any other reader or downloaded through communication I/F 1190 and thereafter temporarily stored in hard disk 1150. The software is then read from hard disk 1150 into RAM 1140 in an executable format and then executed by CPU 1110.

Each hardware included in computer system 1100 shown in FIG. 11 is commonly used. Therefore, it can be said that the most essential part of the present invention as described below is software stored in RAM 1140, hard disk 1150, CD-ROM 1162 or any other data recording medium or software that can be downloaded via a network. It is noted that the operation of each hardware of computer system 1100 is well known and therefore detailed description thereof will not be repeated here.

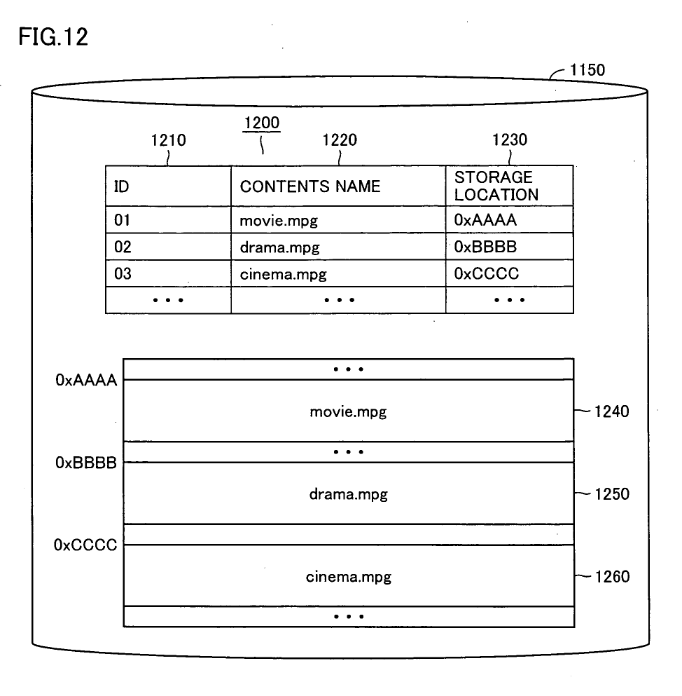

Referring to FIG. 12, a data structure of computer system 1100 will be described. FIG. 12 is a diagram schematically illustrating a manner of data storage in hard disk 1150. Hard disk 1150 stores a table 1200 representing contents management information and contents. Table 1200 includes a region 1210 for storing an identification number of contents, a region 1220 for storing the name of contents, a region 1230 for storing the location where each of contents is stored.

Hard disk 1150 further includes regions 1240, 1250, 1260 for storing specific data for each of contents. For example, region 1240 starts at address 0xAAAA. Region 1240 is associated with the storage location stored in region 1230 of table 1200. This is applicable to other contents. A manner of storing contents and a manner of storing management information are not limited to the one shown in FIG. 12. Furthermore, a manner of data storage in hard disk 1150 can be easily understood by those skilled in the art. Therefore, the detailed description will not be repeated here.

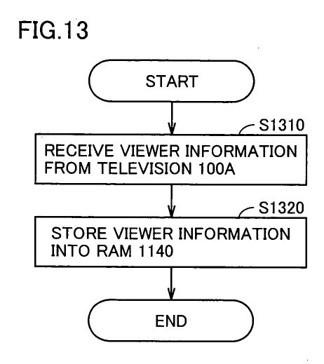

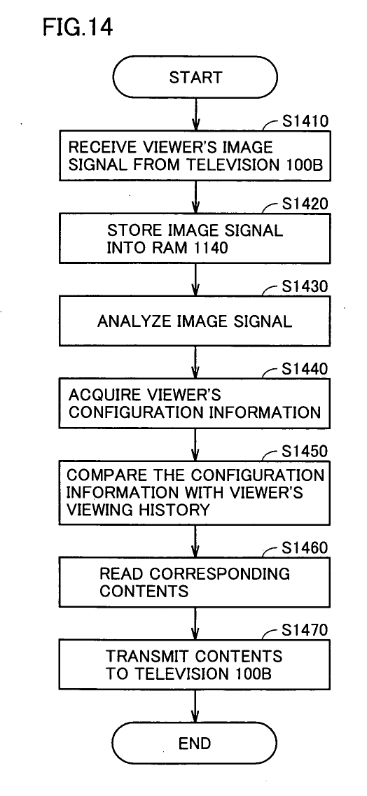

Referring to FIG. 13 and 14, a control structure of the media server in accordance with the present embodiment will be described. Here, a user (referred to as the viewer hereinafter) who watches television 100A subsequently watches television 100B, by way of illustration. FIGS. 13 and 14 are flowcharts illustrating a procedure of processes performed by CPU 1110 of computer system 1100 which functions as media server 200. This process is performed when viewer information is received from a television.

At step S1310, CPU 1110 receives viewer information from television 100A. At step S1320, CPU 1110 temporarily stores the viewer information into RAM 1140. Thereafter, CPU 1110 stores the viewer information stored in RAM 1140 into a region reserved in hard disk 1150 with reference to the data in hard disk 1150. It is noted that if old information of the same viewer has already existed in hard disk 1150, the information may be overwritten.

When the viewer changes a device for seeing contents from television 100A to television 100B, television 100B picks up an image of the user for media server 200 to perform a process for providing contents to the viewer.

More specifically, as shown in FIG. 14, CPU 1110 receives a viewer's image signal from television 100B via network 11 at step S1410: At step S 1420, CPU 1110 stores the image signal into RAM 1140. At step S1430, CPU 1110 analyzes the image signal. At step S1440, CPU 1110 acquires configuration information of the viewer. At step S1450, CPU 1110 compares the acquired configuration information with the configuration history of the viewer. At step S1460, CPU 1110 detects the configuration history corresponding to the configuration information as a result of comparison and reads the contents corresponding to the configuration history. At step S1470, CPU 1110 transmits the contents as a video/audio signal to television 100B.

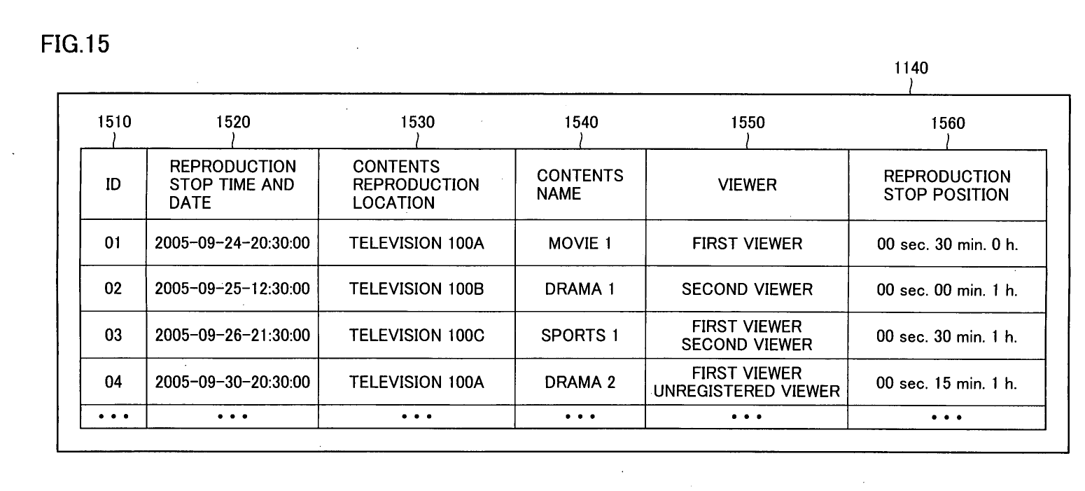

Referring to FIG. 15, a data structure of media server 200 will be described. FIG. 15 is a diagram illustrating a manner of data storage in RAM 1140 of computer system 1100. RAM 1140 includes regions 1510 to 1560 for storing information that manages a history of contents reproduction.

A reproduction ID for identifying a reproduction record is stored in region 1510. Data of the time at which reproduction of contents was stopped is stored in region 1520. Data for specifying the location where contents are reproduced is stored in region 1530. This data may be data identifying the television itself or data identifying a room where the television is installed. Such data is input, for example, when the user constructs viewer system 10. Data for specifying the contents that has been reproduced (for example, the name of contents) is stored in region 1540. Data for specifying the viewer of contents is stored in region 1550. Data for specifying the position at which the reproduction of contents is stopped is stored in region 1560. This data is the time from the start of contents, an address of a disk at which contents are stored, or the like.

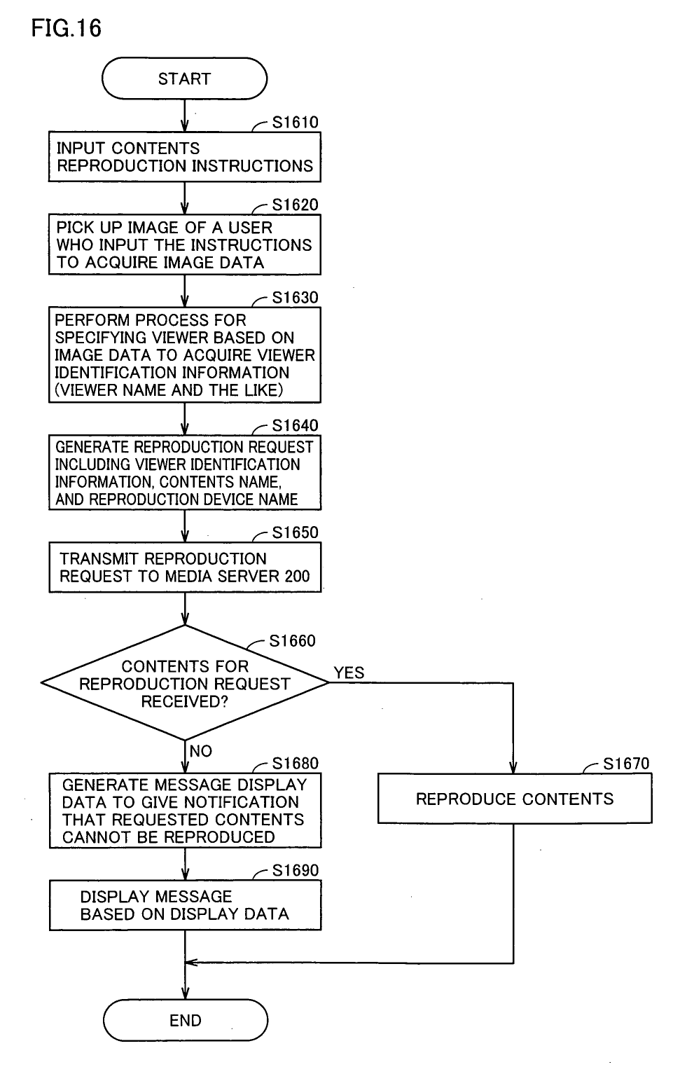

Referring to FIG. 16, a control structure of television 100 in accordance with the present embodiment will be further described. FIG. 16 is a flowchart illustrating a procedure of processes performed by CPU 310 when a viewer instructs television 100 to reproduce contents.

At step S1610, CPU 310 detects an input of a contents reproduction instruction based on a signal from light-receiving unit 306 or a signal from operation unit 308. At step S1620, CPU 310 transmits an image pickup instruction to camera 350 to pick up an image of the viewer who inputs the reproduction instruction and acquire image data of the viewer. At step S1630, CPU 310 performs a process for specifying the viewer based on the image data to obtain a viewer ID. At step S1640, CPU 310 generates a contents reproduction request. The reproduction request includes the viewer identification information (viewer ID) obtained at step S1630, the contents name, and the reproduction device (television 100). At step S1650, CPU 310 transmits the reproduction request to media server 200 through communication I/F 370.

At step S1660, CPU 310 determines whether or not the contents corresponding to the reproduction request is received from media server 200. If television 100 receives the contents (YES at step S1660), the process goes to step S1670. If not (NO at step S1660), the process goes to step S1680.

At step S1670, CPU 310 reproduces the contents received through communication I/F 370. Specifically, the data of the contents is input from communication I/F 370 to signal processing circuit 320. Signal processing circuit 320 sends the signal to driver 328. As a result, the contents transmitted from media server 200 appear on display 330. At step S1680, CPU 310 generates data for displaying a message to give notification that the requested contents cannot be reproduced. The message is formed, for example, of a text stored beforehand in memory 312. At step S1690, CPU 310 causes the display 330 to display the message based on the generated data.

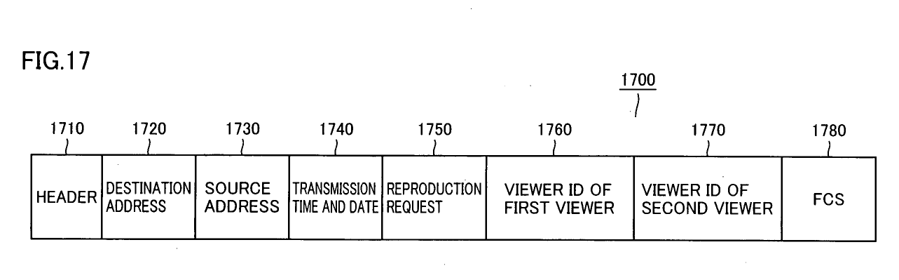

Referring now to FIG. 17, the communication between television 100 and media server 200 will be further described. FIG. 17 is a diagram schematically illustrating a structure of a reproduction request 1700 transmitted from television 100 to media server 200.

Reproduction request 1700 includes a header 1710, a destination address 1720, a source address 1730, transmission time and date 1740, data representing a reproduction request 1750, a viewer ID 1760 of a first viewer, a viewer ID 1770 of a second viewer, and FCS 1780. Shown here is a reproduction request in the case where two viewers request reproduction of contents. However, the structure of the reproduction request is not limited to the one shown in FIG. 17. In other words, the number of viewers may be one or three or more. If there exist three or more viewers, each viewer ID is stored before FCS 1780.

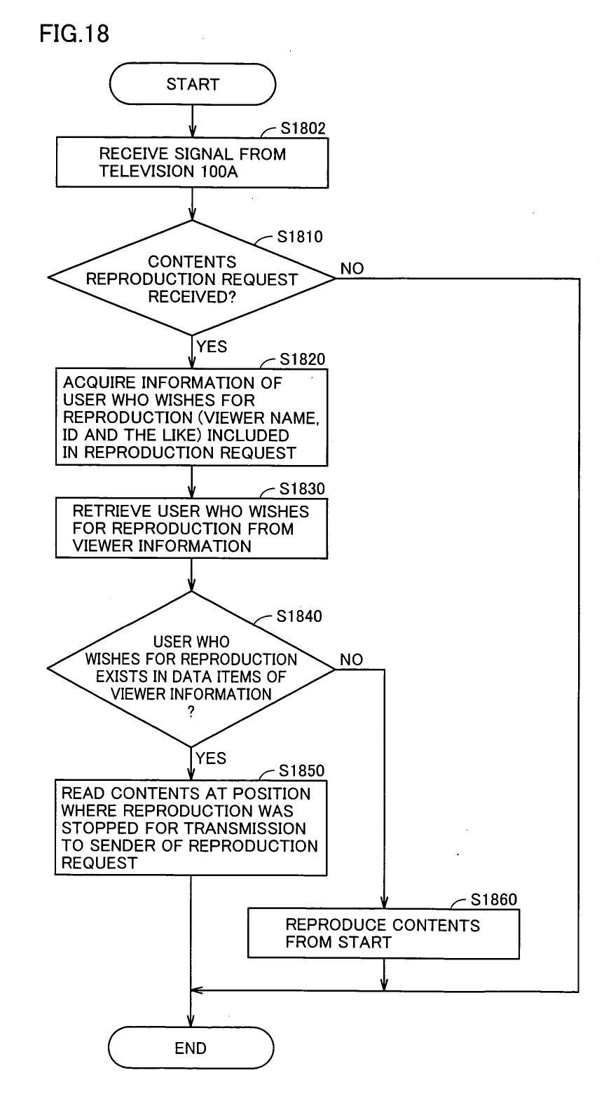

Referring to FIG. 18, a control structure of media server 200 will be further described. FIG. 18 is a flowchart illustrating a procedure of processes performed by computer system 1100 which has received a contents reproduction request.

At step S1802, CPU 1110 detects that a signal has been received from television 100A based on a signal received through communication I/F 1190. At step S1810, CPU 1110 determines whether or not a contents reproduction request has been received based on the information included in the signal. If CPU 1110 determines that the contents reproduction request has been received (YES at step S1810), the process goes to step S1820. If not (NO at step S1810), the process ends.

At step S1820, CPU 1110 acquires viewer information of a viewer who wishes for reproduction, which is included in the reproduction request (the name of the viewer, a viewer ID, and the like). At step S1830, CPU 1110 retrieves the user who wishes for reproduction from the viewer information. At step S1840, CPU 1110 determines whether or not the user who wishes for reproduction exists in the database of the viewer information (FIG. 15). If the user who wishes for reproduction exists in the database (YES at step S1840), the process goes to step S1850. If not (NO at step S1840), the process goes to step S1860.

At step S1850, with reference to the reproduction stop position (region 1560) included in the database, CPU 1110 reads the contents data corresponding to the position at which reproduction was stopped and transmits the same to the sender (television 100A) of the reproduction request. At step S1860, CPU 1110 reads data of the contents requested to be reproduced from the beginning for transmission to the sender of the reproduction request. In this case, television 100A reproduces the contents from the beginning again.

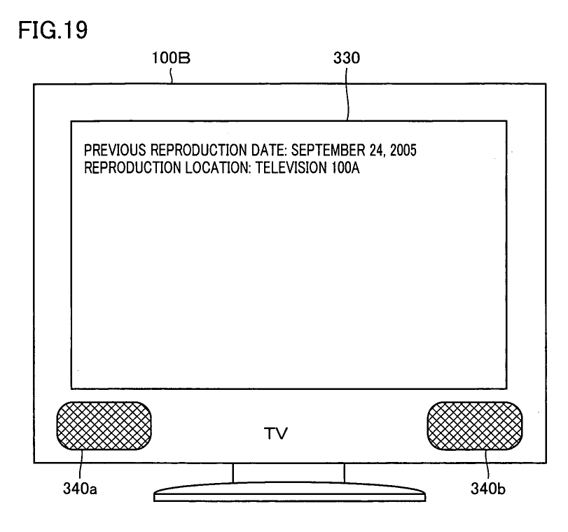

Referring to FIG. 19, a display manner of television 100 in accordance with the present embodiment will be described. FIG. 19 is a diagram illustrating a message displayed when contents are reproduced. Specifically, when reproduction of contents is requested and thereafter the contents are to be actually reproduced, display 330 of television 100 displays the date when contents were reproduced last time. More specifically, television 100 receives data of the reproduction stop time and date (region 1520 in FIG. 15) from media server 200 at the start of reproduction of the contents and displays the information on display 330. In this way, the viewer can easily confirm that the contents to be reproduced from now on are the correct one.

As described above, in viewing system 10 in accordance with the first embodiment of the present invention, media server 200 included in viewing system 10 stores a feature amount as information for specifying a viewer. Media server 200 stores the history of viewing contents by a viewer on a reproduction device (for example, televisions 100A, 100B, 100C) included in viewing system 10. In response to a contents reproduction request from each reproduction device, media server 200 determines whether or not the same viewer viewed the contents in the past. If there exist contents viewed in the past, media server 200 transmits the contents to the reproduction device that has transmitted the reproduction request. As a result, the viewer can continuously view the same contents even if the contents viewing location (for example, a television for viewing) is changed. Therefore, viewing system 10 saves the time and effort to managing each of the contents to view a number of contents.

<Second Embodiment>

In the following, a second embodiment of the present invention will be described. A viewing system in accordance with the present embodiment differs from viewing system 10 in accordance with the first embodiment as described above in that the media server performs a viewer analysis process.

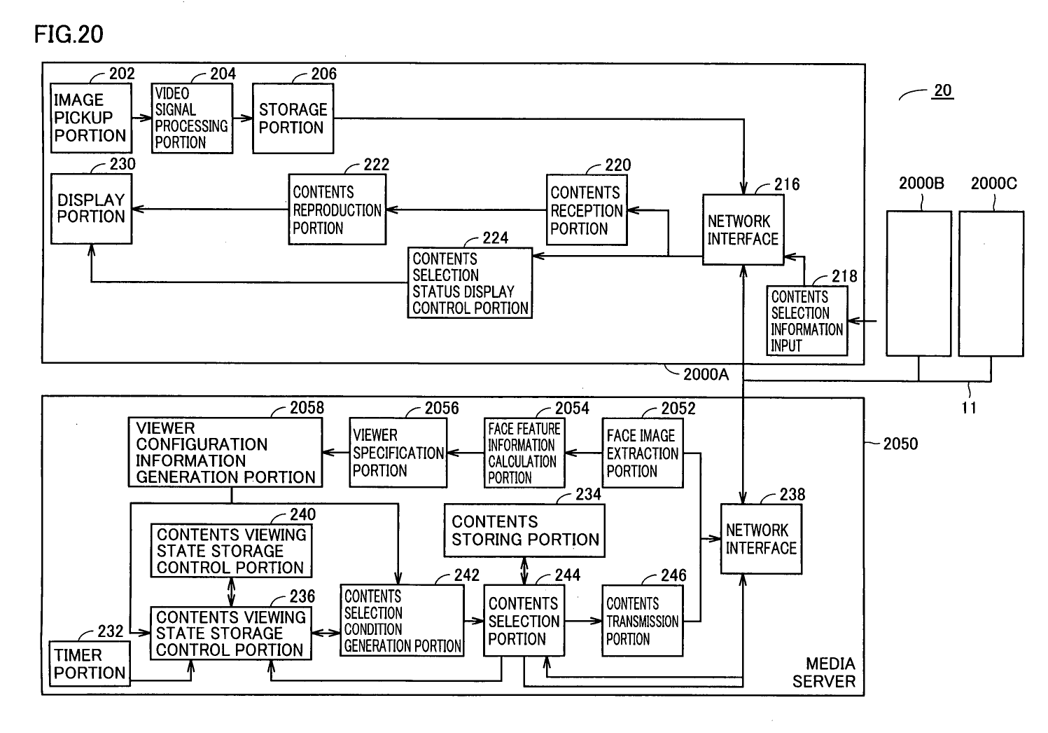

Referring to FIG. 20, the technical idea to realize a viewing system 20 in accordance with the present embodiment will be described. FIG. 20 is a block diagram illustrating a functional configuration of viewing system 20.

Viewing system 20 includes televisions 2000A, 2000B, 2000C, serving as exemplary display equipment for displaying video, and a media server 2050. Televisions 2000A, 2000B, 2000C and media server 2050 are connected to each other via network 11. The functional configuration of television 2000A differs from the configuration of television 100A shown in FIG. 2 in that it does not have a function of performing an analysis process. More specifically, television 2000A does not have face image extraction portion 208, face feature information calculation portion 210, viewer specification portion 212, and viewer configuration information generation portion 214 shown in FIG. 2. The other configuration of television 2000A is the same as the configuration of television 100A shown in FIG. 2. Therefore, description thereof will not be repeated here.

In addition to the configuration of media server 200 shown in FIG. 2, media server 2050 includes a face image extraction portion 2052 for extracting a face image of a viewer based on information received through network interface 238, a face feature information calculation portion 2054 calculating information representing the feature of the viewer's face from the face image data extracted by face image extraction portion 2052, a viewer specification portion 2056 for specifying the viewer of display equipment based on the information calculated by face feature information calculation portion 2054, and a viewer configuration information generation portion 2058 generating information representing the viewer who watches the display equipment based on viewer information (for example, the ID, name or the like for identifying the viewer) specified by viewer specification portion 2056.

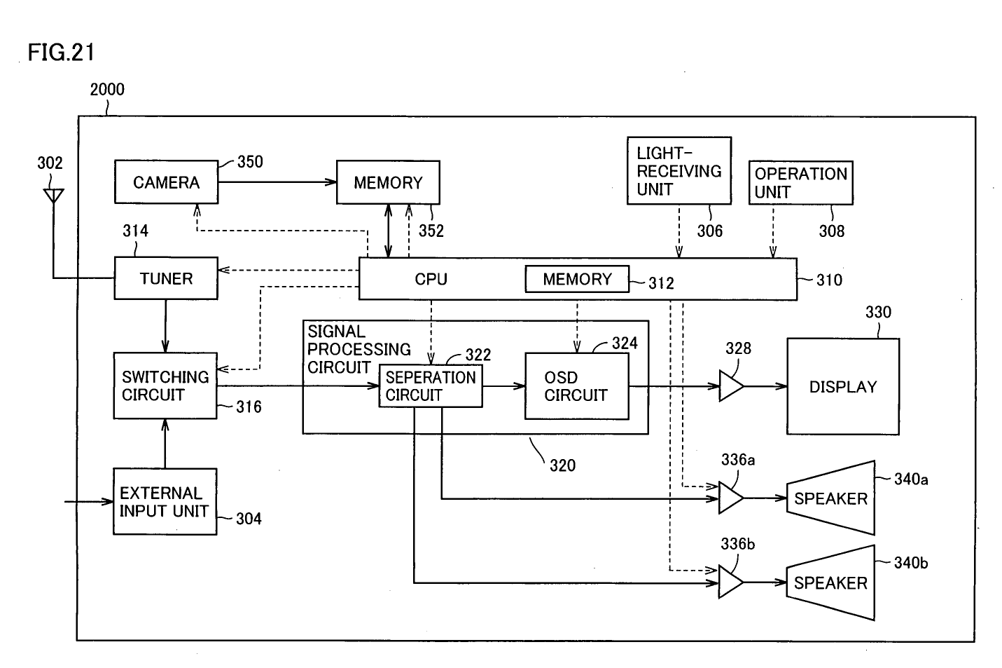

Referring to FIG. 21, a television 2000 included in viewer system 20 in accordance with the present embodiment will be described. FIG. 21 is a block diagram representing a hardware configuration of television 2000. Television 2000 differs from the configuration shown in FIG. 3 in that television 2000 does not have analysis unit 360. The other hardware configuration of television 2000 is the same as the one shown in FIG. 3. Therefore, description thereof will not be repeated here.

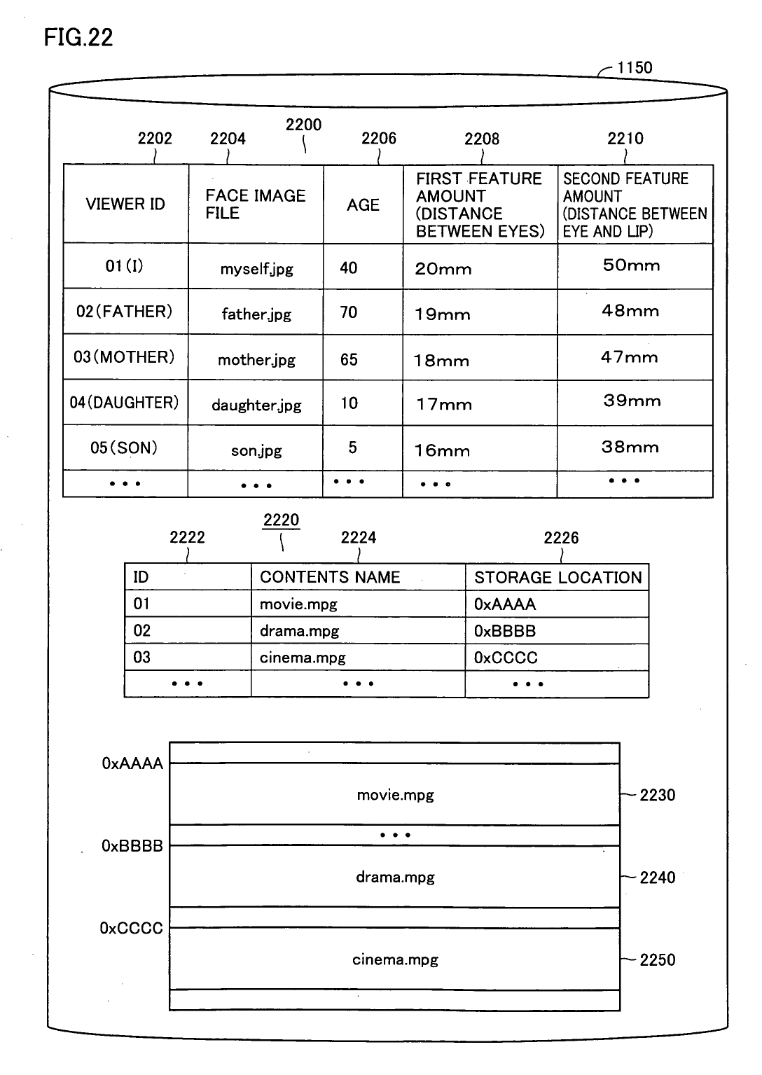

Referring to FIG. 22, a data structure of media server 2050 will be described. FIG. 22 is a diagram illustrating a manner of data storage in hard disk 1150. Hard disk 1150 stores a table 2200 having information of a viewer registered beforehand, a table 2220 having management information of the contents stored in media server 2050, and data of each of contents.

Table 2200 includes a viewer ID 2202 for identifying the registered viewer, face image data 2204 acquired by picking up an image of a viewer, viewer's attribute information 2206 (for example, age), and feature amounts 2208, 2210 of the viewer's face image. Table 2220 includes an ID 2222 for identifying the contents registered in media server 2050, contents name 2224, and data 2226 representing the location where the contents are stored. Specifically, contents are stored in each of the regions specified by regions 2230, 2240, 2250. The data items included in table 2220 are related with each other. Therefore, the corresponding contents (region 2224) are specified by designating the ID stored in region 2222, and specific data is read with reference to any of regions 2230 to 2250.

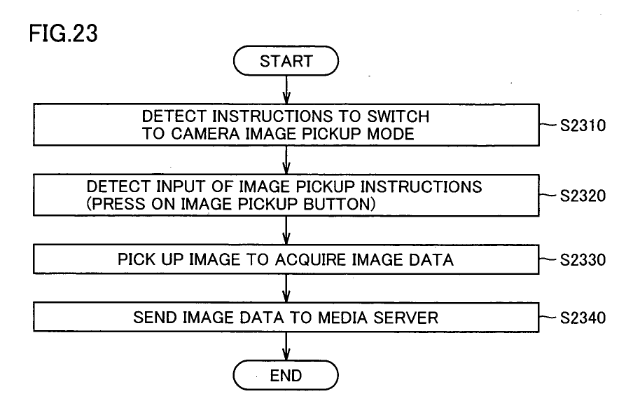

Referring to FIG. 23, a control structure of television 2000A in accordance with the present embodiment will be described. FIG. 23 is a flowchart illustrating a procedure of processes performed by CPU 310 of television 2000A to register a viewer.

At step S2310, CPU 310 of television 2000A detects an instruction to change its operation mode to a camera image pickup mode. This detection is based on, for example, a signal from a remote control terminal (not shown), which is received through light-receiving unit 306. At step S2320, CPU 310 detects an input of an image pickup instruction based on a signal from light-receiving unit 306. At step S2330, CPU 310 transmits the image pickup instruction to camera 350 to pick up an image of a viewer present in front of camera 350 and acquire image data. At step S2340, CPU 310 transmits the image data to media server 250 through communication I/F 370.

In this way, when the image data is transmitted from television 2000A to media server 2050, media server 2050 performs an analysis process on the image data to calculate the feature amount of the viewer's face image. The analysis process is performed in face image extraction portion 2052, face feature information calculation portion 2054, viewer specification portion 2056, and viewer configuration information generation portion 2058 shown in FIG. 20.

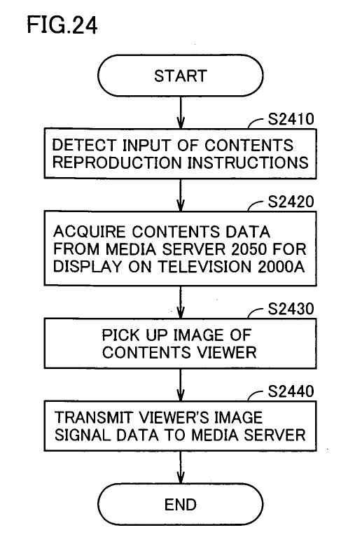

Referring to FIG. 24, a control structure of television 2000A included in viewing system 20 will be described. FIG. 24 is a flowchart illustrating a procedure of processes performed by CPU 310 when a viewer of television 2000A views contents.

At step S2410, CPU 310 detects an input of a contents reproduction instruction based on a signal from light-receiving unit 306 or operation unit 308. At step S2420, CPU 310 acquires contents data from media server 2050 for display on television 2000A. At step S2430, CPU 310 transmits an image pickup signal to camera 350 to pick up an image of the viewer present in front of camera 350. The signal generated by image pickup is temporarily stored in memory 352. At step S2440, CPU 310 transmits the viewer's image data to media server 2050.

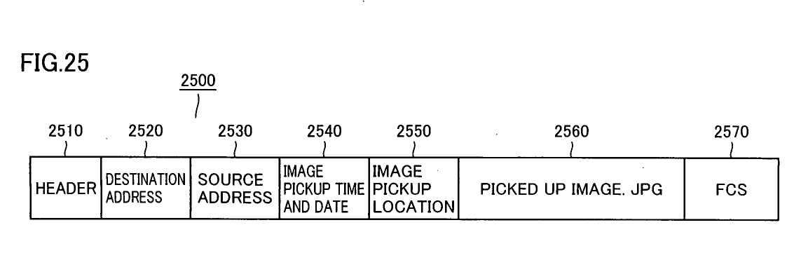

Referring now to FIG. 25, communication between display equipment and media server 2050 in the present embodiment will be described. FIG. 25 is a diagram illustrating a signal transmitted by television 2000A to media server 2050. A signal 2500 includes a header 2510, a destination address 2520, a source address 2530, image pickup time and date 2540, image pickup location 2550, image data 2560, and FCS 2570.

Destination address 2520 is data for specifying the location of media server 2050 in network 11. Source address 2530 is data for specifying the location of television 2000A in network 11. Image pickup time and date 2540 is the time when an image was picked up by camera 350. Image pickup location 2550 is the location where an image was picked up by camera 350 (for example, identification data of television 2000A, data for specifying the room where television 2000A is arranged, or the like). Image data 2560 is data output, for example, from camera 350. The data format is not specifically limited.

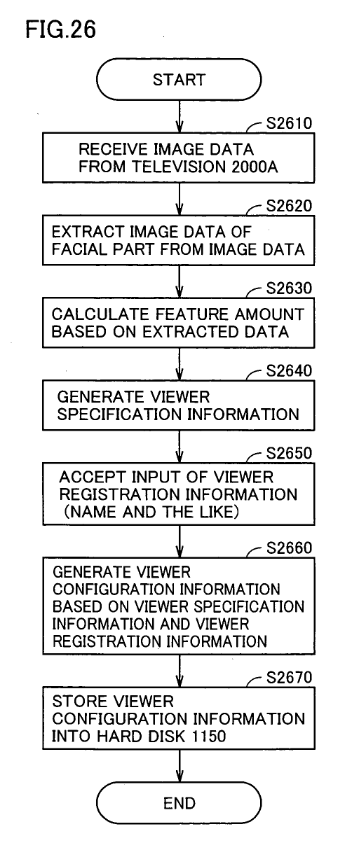

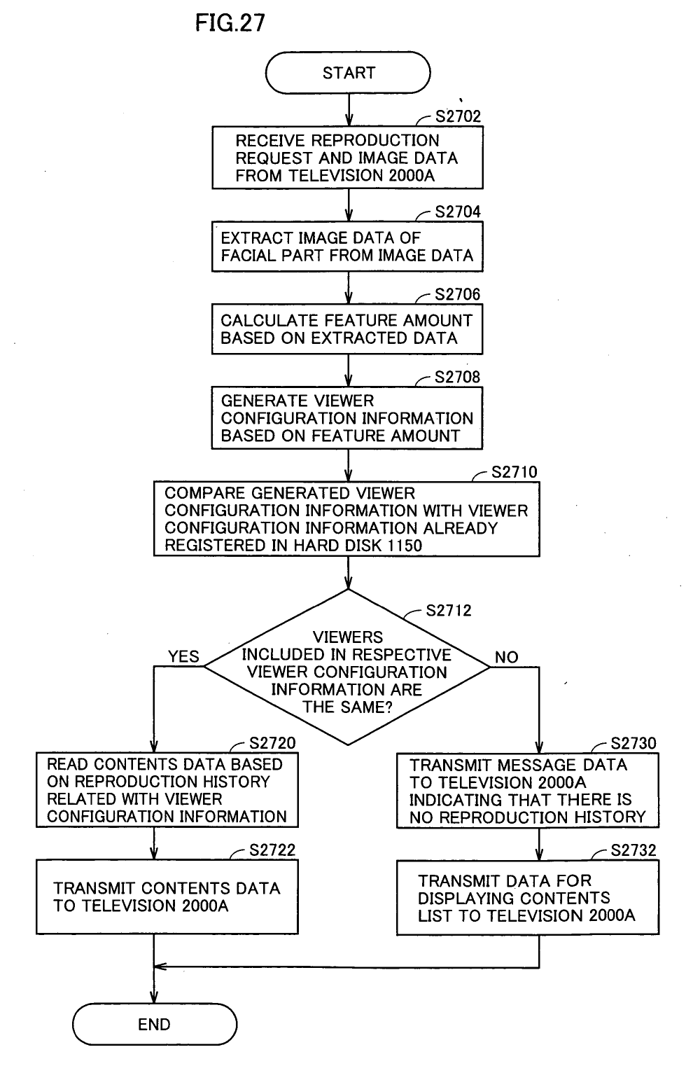

Referring now to FIGS. 26 and 27, a control structure of media server 2050 in accordance with the present embodiment will be described. It is noted that media server 2050 is implemented, for example, by computer system 1100. Then, in the following, an operation of computer system 1100 will be described. FIG. 26 is a flowchart illustrating a procedure of processes performed by CPU 1110 to register information of a viewer.

At step S2610, CPU 1110 receives image data from television 2000A via network 11. At step S2620, CPU 1110 extracts image data of the facial part of the viewer from the image data. At step S2630, CPU 1110 calculates the feature amount of the face based on the extracted image data. At step S2640, CPU 1110 generates viewer specification information based on the calculated feature amount. Here, the viewer specification information refers to the value of the ratio between a plurality of feature amounts.

At step S2650, CPU 1110 accepts an input of viewer registration information (the viewer's name, age and any other attribute information) through mouse 1120 or keyboard 1130. At step S2660, CPU 1110 generates viewer configuration information using the viewer specification information generated at step S2640 and the viewer registration information accepted at step S2650. The viewer configuration information includes the viewer ID and the feature amount. At step S2670, CPU 1110 stores the viewer configuration information in a region reserved in hard disk 1150.

FIG. 27 is a flowchart illustrating a procedure of processes performed by CPU 1110 when media server 2050 reproduces contents.

At step S2702, CPU 1110 receives a contents reproduction request and the viewer's image data from television 2000A via network 11. At step S2704, CPU 1110 extracts image data of the facial part from the image data. At step S2706, CPU 1110 calculates the feature amount of the face using the extracted image data. At step S2708, CPU 1110 generates viewer configuration information based on the calculated feature amount. At step S2710, CPU 1110 compares the viewer configuration information generated at step S2708 with viewer configuration information already registered in hard disk 1150.

At step S2712, CPU 1110 determines whether or not the viewer included in each viewer configuration information is the same as the viewer included in the viewer configuration information already registered. If the viewers are the same (YES at step S2712), the process goes to step S2720. If not (NO at step S2712), the process goes to step S2730.

At step S2720, CPU 1110 reads the contents data requested to be reproduced based on a reproduction region related with the viewer configuration information. At step S2722, CPU 1110 transmits the read contents data to television 2000A.

At step S2730, CPU 1110 transmits message data to television 2000A indicating that no reproduction history exists. At step S2732, CPU 1110 transmits data for displaying a contents list to television 2000A. When television 2000A receives this data, its display 330 displays a list of the contents stored in media server 250. The viewer can select other contents with reference to the list.

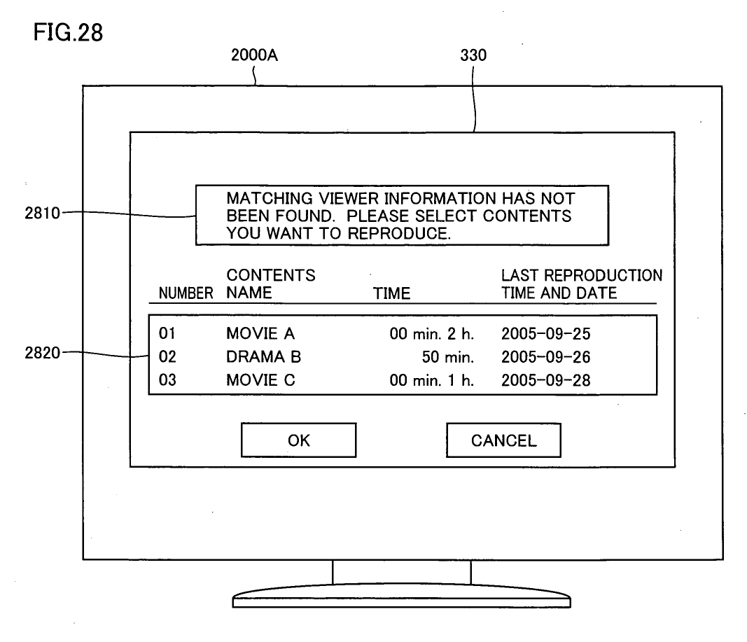

Referring now to FIG. 28, a manner of displaying video on television 2000A will be described. FIG. 28 is a diagram illustrating display of a list of the contents stored in media server 2050 on display 330.

If contents reproduction is requested on television 2000A and the contents do not exist, media server 2050 transmits message data to television 2000A indicating that no reproduction history exists. Thereafter, media server 2050 additionally transmits a contents list. Upon reception of the data, television 2000A displays the message and the contents list as shown in FIG. 28.

Specifically, a message that the contents desired for reproduction do not exist is displayed in a region 2810. A list of contents stored in media server 2050, that is viewable contents, is displayed in a region 2820. The viewer operates a remote control terminal (not shown) to select the name or number of contents in the list displayed in region 2820 and presses a region representing OK to complete the selection of contents. Data representing the selection of contents is transmitted to media server 2050. Thereafter, contents data is transmitted from media server 2050 to television 2000A so that the contents are displayed on television 2000A.

As described above, in viewing system 20 in accordance with the present embodiment, a signal of a viewer whose image is picked up at television 2000 is transmitted to media server 2050. Media server 2050 analyzes the signal to specify the viewer of television 2000 and generates information including viewer information and contents information as viewer configuration information if particular contents are viewed. Media server 2050 uses the viewer configuration information to refer to the past viewing history for the viewer who wishes for contents reproduction. If there exists a history including the same viewer information, media server 2050 confirms that the reproduction of the contents is stopped halfway and then reads the contents for transmission to television 2000 that requests reproduction.

In this way, television 2000 or any other display equipment needs not include a function of analyzing the viewer's face image. Therefore, the complicated configuration of television 2000 can be prevented.

In addition, since media server 2050 collectively manages contents, the user of viewing system 20 does not have to manage a number of contents any longer. Therefore, the convenience in viewing contents may be improved.

<Third Embodiment>

In the following, a third embodiment of the present invention will be described. A media server in accordance with the present embodiment differs from each of the foregoing embodiments in that the server has a function of reproducing contents at a position just before the position at which reproduction was stopped. It is noted that the media server in accordance with the present embodiment is implemented by the same hardware configuration as the media server shown in the first or second embodiment. Therefore, description thereof will not be repeated here. The media server in accordance with the present embodiment is realized by changing the process performed in computer system 1100.

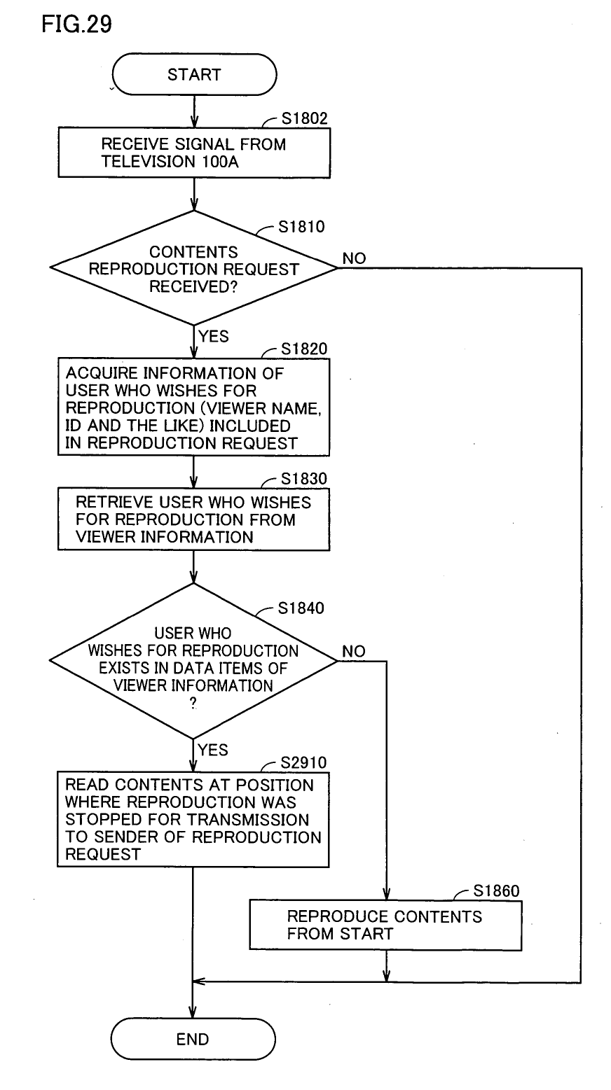

Referring to FIG. 29, a control structure of the media server in accordance with the present embodiment will be described. FIG. 29 is a flowchart illustrating a procedure of processes performed by CPU 1110. It is noted that the same processes as the foregoing processes are denoted with the same step numbers. Therefore, description thereof will not be repeated here.

At step S1840, CPU 1110 determines whether or not a data for a user who wishes for reproduction exists in the data items of the viewer information. If the data for the user who wishes for reproduction exists in the data items of the viewer information (YES at step S1840), the process goes to step S2910. If not (NO at step S1840), the process goes to step S1860.

At step S2910, CPU 1110 reproduces contents back from the reproduction stop position of the contents requested to be reproduced by a predetermine period of time. For example, a predetermined period of time is 30 seconds, 1 minute, or any other time. The period of time reflects the time kept by a timer circuit (not shown) included in media server 200 as a reproduction history. For example, if the reproduction stop time and date is 21:30:00, Sep. 25, 2005, and the location of the contents is for example “0xbbbb”, the location at which contents are reproduced again is “0xbbaa”, which location corresponds to 21:29:00, Sep. 25, 2005.

In this way, even when a viewer views the same contents on different display equipment, the scene at which viewing was broken off can be viewed again thereby to recall the specifics of the contents easily. In this case, the amount of contents to be reproduced back in time is not limited to a fixed value and may be variable. For example, if time has passed since the reproduction was stopped, the amount of going back may be increased according to the elapsed time.

<Modification>

In the following, a modification to each embodiment will be described. In each of the foregoing embodiments, television 100, 2000 as exemplary display equipment contains a camera. However, a television in accordance with the present embodiment does not always have to contain a camera. In this case, the television can acquire information of a viewer by accepting an input of analyzed data from a camera.

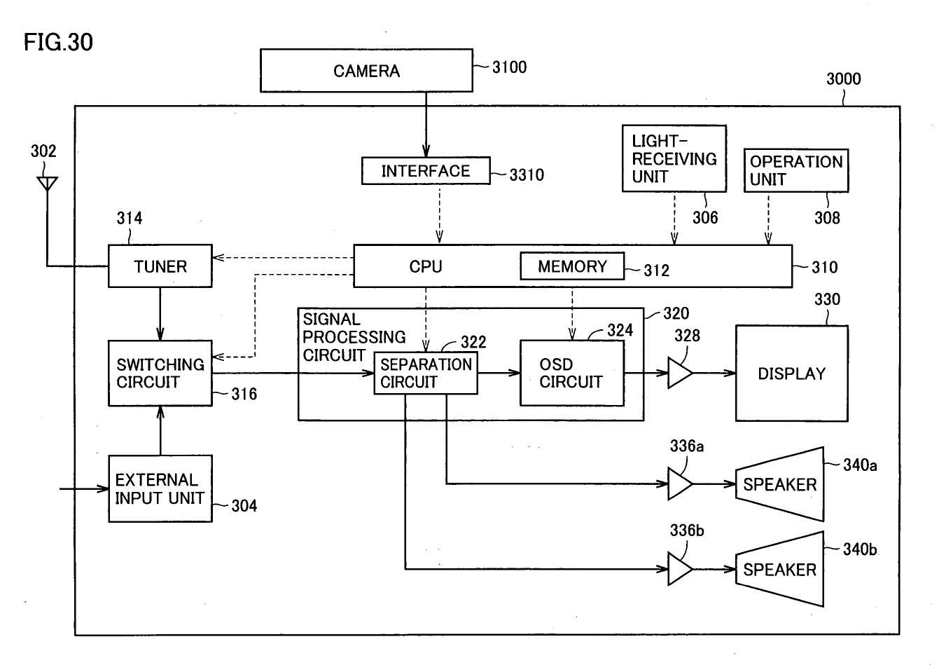

Referring now to FIG. 30, a configuration of a television 3000 in this modification will be described. FIG. 30 is a block diagram illustrating a hardware configuration of television 3000 to which a camera 3100 is connected. Television 3000 differs from the configuration shown in FIG. 3 in that television 3000 does not have a camera, a memory, and an analysis unit. Television 3000 further includes an interface 3310 connected to CPU 310. Interface 3310 accepts an input of a signal output from camera unit 3100 for transmission to CPU 310.

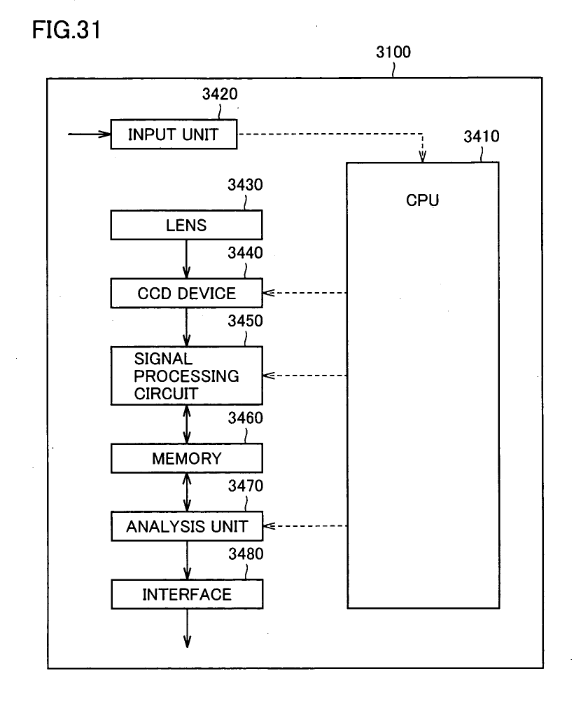

Referring to FIG. 31, camera unit 3100 having an analysis function will be described. FIG. 31 is a block diagram illustrating a hardware configuration of camera unit 3100. Camera unit 3100 includes an input unit 3420, a CPU 3410, a lens 3430, a CCD device 3440, a signal processing circuit 3450, a memory 3460, an analysis unit 3470, and an interface 3480.

Input unit 3420 accepts an input of a signal from the outside. The externally input signal includes a control signal input from television 3000, a control signal from a corresponding remote control terminal (not shown), if camera unit 3100 has a remote control function, and the like. The signal is sent to CPU 3410. CPU 3410 controls an operation of each hardware of camera unit 3100 based on the input signal.

Lens 3430 is placed at a predetermined position on camera unit 3100. Optical signals collected by lens 3430 are sent to CCD device 3440. CCD device 3440 is driven based on instructions from CPU 3410, converts an optical signal into an electrical signal, and sends the generated electrical signal to signal processing circuit 3450. Signal processing circuit 3450 performs predetermined signal processing for electrical charges output from CCD device 3440 based on an instruction output from CPU 3410. The data output from signal processing circuit 3450 is stored in a region reserved beforehand in memory 3460.

Analysis unit 3470 reads the data stored in memory 3460 based on a command from CPU 3410 to perform an analysis process using that data. Specifically, analysis unit 3470 realizes a function similar to analysis unit 360 shown in FIG. 3. Interface 3480 accepts an input of a signal output from analysis unit 3470. Interface 3480 outputs that signal to the outside of camera unit 3100. Accordingly, the analysis result is transmitted to television 3000.

In this way, television 3000 is implemented by a device having a conventional configuration, so that an existing television receiver device can function as the television receiver device in accordance with the present invention only by connecting with camera unit 3100.

As detailed above, the viewing system in accordance with each embodiment of the present invention facilitates viewing the same contents even in different rooms to make it easier to use contents stored in a hard disk device or any other mass storage device. For example, a viewer no longer has to search for a reproduction position while skipping the already viewed part for the contents he/she wishes for reproduction, so that the viewer can view the contents easily and quickly.

Furthermore, in the viewing system, in viewing contents, the viewer's face image is acquired and the feature amount of the viewer is calculated. Therefore, in reproducing contents, a viewer authentication process is performed without the viewer being aware of it. Therefore, when the same viewer inputs a reproduction instruction, contents to be successively reproduced are searched for by the media server or any other video recording and reproduction device based on the past viewing history of the viewer. Thus, even if the viewer breaks off reproduction of contents halfway, the viewer can carry out subsequent reproduction in a continuous manner.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A system for reproducing video having first and second video display devices connected to a network and a video recording and reproduction device connected to said network,
said video recording and reproduction device including:
a recording unit storing video/audio contents having a video/audio signal;
a reproduction unit reproducing said video/audio signal; and
a distribution control unit responsive to an externally input request for distributing a video/audio signal corresponding to video/audio contents to a sender of said request,
said first video display device including:
a first acquisition unit acquiring an image signal by picking up an image of a subject;
a first calculation unit calculating a feature amount of the subject by analyzing said image signal;
an identification information storing unit storing first identification information of said subject and said feature amount related with said first identification information;
a first reproduction control unit causing said video recording and reproduction device to reproduce said video/audio contents based on a first reproduction request;
a first display unit displaying the video/audio contents reproduced by said video recording and reproduction device;
a first acquisition control unit causing said first acquisition unit to acquire an image signal by picking up an image of a first viewer who gives an instruction of said reproduction;
a first generation unit generating first specification information for specifying said first viewer based on said image signal of said first viewer and said first identification information; and
a history transmission unit transmitting said first specification information and a reproduction history related with said first specification information to said video recording and reproduction device,
said video recording and reproduction device further including a history storing unit storing said first specification information and said reproduction history,
said second video display device including:
a second acquisition unit acquiring an image signal by picking up an image of a subject;
a second calculation unit calculating a feature amount of the subject based on said image signal;
a second identification information storing unit storing second identification information of said subject and said feature amount related with said second identification information;
a second acquisition control unit causing said second acquisition unit to acquire the image signal by picking up an image of a second viewer who inputs a second reproduction request;
a second generation unit generating second specification information for specifying said second viewer based on said feature amount and said acquired image signal;
a second reproduction control unit causing said video recording and reproduction device to reproduce said video/audio contents requested to be reproduced based on said second specification information and said second reproduction request; and
a second display unit displaying the video/audio contents based on the video/audio signal reproduced by said video recording and reproduction device.

2. The system according to claim 1, wherein
said first acquisition unit includes a first image pickup unit picking up an image of said subject to output an image signal,
said first acquisition control unit controls an image pickup operation by said first image pickup unit,
said second acquisition unit includes a second image pickup unit picking up an image of said subject to output an image signal, and
said second acquisition control unit controls an image pickup operation by said second image pickup unit.

3. The system according to claim 1, wherein
said first acquisition unit includes a first signal input unit accepting an input of the image signal generated by picking up an image of said subject, and
said second acquisition unit includes a second signal input unit accepting an input of the image signal generated by picking up an image of said subject.

4. The system according to claim 1, wherein said first calculation unit calculates a feature amount of said subject by performing a predetermined analysis process.

5. The system according to claim 1, wherein said second calculation unit calculates a feature amount of said subject by performing a predetermined analysis process.

6. The system according to claim 1, wherein
said first reproduction control unit transmits said first reproduction request to said video recording and reproduction device, and
said distribution control unit transmits a video/audio signal corresponding to video/audio contents requested to be reproduced to said first video display device based on said first reproduction request.

7. The system according to claim 1, wherein said second identification information storing unit stores externally input second identification information of said subject and said feature amount related with said second identification information.

8. The system according to claim 1, wherein
said second reproduction control unit transmits said second specification information and said second reproduction request to said video recording and reproduction device, and
said distribution control unit transmits said video/audio contents requested to be reproduced to said second video display device based on said second reproduction request.

9. The system according to claim 1, wherein said first acquisition control unit causes said first acquisition unit to acquire an image signal of said first viewer based on reproduction of said video/audio signal.

10. The system according to claim 1, wherein
said video recording and reproduction device further includes:
a time lag calculation unit calculating a time lag between a first time at which reproduction ends in said first video display device and a second time at which a reproduction instruction is transmitted by said second video display device; and
an overlapping reproduction control unit causing said reproduction unit to reproduce a video/audio signal corresponding to said video/audio contents requested to be reproduced, back from said first time to a time according to said time lag.

11. The system according to claim 1, wherein
said first acquisition unit includes a first image pickup unit picking up an image of said subject to output an image signal,
said first acquisition control unit controls an image pickup operation by said first image pickup unit and causes said first image pickup unit to acquire an image signal of said first viewer based on reproduction of said video/audio signal,
said second acquisition unit includes a second image pickup unit picking up an image of said subject to output an image signal,
said second acquisition control unit controls an image pickup operation by said second image pickup unit,
said second calculation unit calculates a feature amount of said subject by performing a predetermined analysis process,
said first reproduction control unit transmits said first reproduction request to said video recording and reproduction device,
said distribution control unit transmits a video/audio signal corresponding to video/audio contents requested to be reproduced to said first video display device based on said first reproduction request,
said second identification information storing unit stores externally input second identification information of said subject and said feature amount related with said second identification information,
said second reproduction control unit transmits said second specification information and said second reproduction request to said video recording and reproduction device, and
said distribution control unit transmits said video/audio contents requested to be reproduced to said second video display device based on said second reproduction request.

12. A system for reproducing video, said system having first and second video display devices connected to a network and a video recording and reproduction device connected to said network,
said video recording and reproduction device including:
a recording unit storing video/audio contents having a video/audio signal; and
a reproduction unit reproducing said video/audio signal, said first video display device including:
a first acquisition unit acquiring an image signal by picking up an image of a subject;
a first transmission unit transmitting said image signal to said video recording and reproduction device; and
a first request transmission unit transmitting a first reproduction request externally input to reproduce video/audio contents to said video recording and reproduction device,
said video recording and reproduction device further including:
an analysis unit calculating a feature amount of an image by performing a predetermined analysis process on the image signal;
a viewer information storing unit storing identification information for identifying a viewer and a feature amount related with said identification information;
a first calculation unit causing said analysis unit to calculate a first feature amount of a first viewer who makes said first reproduction request based on the image signal from said first video display device;
a first reproduction control unit causing said reproduction portion to reproduce a video/audio signal corresponding to video/audio contents requested to be reproduced based on said first reproduction request,
a first distribution unit transmitting a read video/audio signal to said first video display device, and
a management unit managing a history of reproduction for said first video display device based on said identification information and said first feature amount,
said first video display device further including a first display unit displaying video/audio contents based on a video/audio signal transmitted from said video recording and reproduction device,
said second video display device including:
a second request transmission unit transmitting a second reproduction request externally input to reproduce video/audio contents to said video recording and reproduction device;
a second acquisition unit acquiring an image signal by picking up an image of a subject; and
a second transmission unit transmitting said image signal to said video recording and reproduction device,
said video recording and reproduction device further including:
a second calculation unit causing said analysis unit to calculate a second feature amount of a second viewer who makes said second reproduction request based on the image signal from said second video display device;
a retrieval unit retrieving video/audio contents in which said first viewer matches said second viewer based on said identification information, said second feature amount, and said history of reproduction; and
a second distribution unit transmitting a video/audio signal corresponding to the video/audio contents retrieved by said retrieval unit to said second video display device,
said second video display device further including a second display unit displaying video/audio contents based on a video/audio signal transmitted by said video recording and reproduction device.

13. The system according to claim 12, wherein
said first acquisition unit includes a first image pickup unit picking up an image of said subject to output an image signal,
said first acquisition control unit controls an image pickup operation by said first image pickup unit,
said second acquisition unit includes a second image pickup unit picking up an image of said subject to output an image signal, and
said second acquisition control unit controls an image pickup operation by said second image pickup portion.

14. The system according to claim 12, wherein
said first acquisition unit includes a first signal input unit accepting an input of the image signal generated by picking up an image of said subject, and
said second acquisition unit includes a second signal input unit accepting an input of the image signal generated by picking up an image of said subject.

15. The system according to claim 12, wherein said second acquisition unit acquires said image signal based on an input of said second reproduction request.

16. The system according to claim 12, wherein
said management unit includes:
a first generation unit generating first specification information for specifying said first viewer based on said identification information and said first feature amount; and
a reproduction history storing unit storing said first specification information and reproduced video/audio contents, and
said retrieval unit includes:
a second generation unit generating second specification information for specifying said second viewer based on said identification information and said second feature amount, and
a contents retrieval unit retrieving video/audio contents to be distributed to said second video display device based on said first specification information and said second specification information.

17. The system according to claim 16, wherein said contents retrieval unit retrieves video/audio contents in which said first viewer matches said second viewer.

18. The system according to claim 12, wherein said viewer information storing unit stores said identification information input beforehand to identify a viewer and said feature amount calculated by said analysis process for the image signal of said viewer.

19. The system according to claim 12, wherein
said video recording and reproduction device further includes:
a time lag calculation unit calculating a time lag between a first time at which reproduction ends in said first video display device and a second time at which a reproduction instruction is transmitted by said second video display device, and
an overlapping reproduction control unit causing said reproduction portion to reproduce a video/audio signal corresponding to said video/audio contents requested to be reproduced, back from said first time to a time according to said time lag.

20. The system according to claim 12, wherein
said first acquisition unit includes a first image pickup unit picking up an image of said subject to output an image signal,
said first acquisition control unit controls an image pickup operation by said first image pickup unit,
said second acquisition unit includes a second image pickup unit picking up an image of said subject to output an image signal based on an input of said second reproduction request,
said second acquisition control unit controls an image pickup operation by said second image pickup unit,
said management unit includes:
a first generation unit generating first specification information for specifying said first viewer based on said identification information and said first feature amount; and
a reproduction history storing unit storing said first specification information and reproduced video/audio contents,
said retrieval portion includes:
a second generation unit generating second specification information for specifying said second viewer based on said identification information and said second feature amount; and
a contents retrieval unit retrieving video/audio contents to be distributed to said second video display device based on said first specification information and said second specification information,
said contents retrieval unit retrieves video/audio contents in which said first viewer matches said second viewer, and
said viewer information storing unit stores said identification information input beforehand to identify a viewer and said feature amount calculated by said analysis process for the image signal of said viewer.
